(19) United States
(12) Patent Application Publication
(10) Pub. No.: US 2013/0171365 A1
(43) Pub. Date: Jul. 4, 2013

(54) WOOD TREATMENT METHOD AND APPARATUS EMPLOYING BUNDLE LIFT SYSTEM

(71) Applicant: Eastman Chemical Company, Kingsport, TN (US)

(72) Inventors: Aaron Grills, Kingsport, TN (US); Jared Moore, Kingsport, TN (US); James Stewart Nelson, Kingsport, TN (US); Mark Robert Shelton, Kingsport, TN (US); Carlos Carvajal, Kingsport, TN (US); J. Clayton Carter, Kingsport, TN (US); Brian Atkinson, Farmington Hills, MI (US); Harold Dail Kimrey, JR., Knoxville, TN (US)

(73) Assignee: Eastman Chemical Company, Kingsport, TN (US)

(21) Appl. No.: 13/688,979

(22) Filed: Nov. 29, 2012

Related U.S. Application Data
(60) Provisional application No. 61/581,268, filed on Dec. 29, 2011.
(60) Provisional application No. 61/581,273, filed on Dec. 29, 2011.
(60) Provisional application No. 61/581,271, filed on Dec. 29, 2011.
(60) Provisional application No. 61/581,269, filed on Dec. 29, 2011.
(60) Provisional application No. 61/581,266, filed on Dec. 29, 2011.
(60) Provisional application No. 61/581,264, filed on Dec. 29, 2011.

(51) Int. Cl. B27K 3/02; B27K 5/00

(52) U.S. Cl. CPC B27K 3/02; B27K 5/001
USPC 427/440; 432/87; 219/679; 432/9; 414/222.01; 414/806; 118/423

(57) ABSTRACT

A wood treatment system that includes at least one wood treatment vessel and a bundle lift system for loading and unloading a bundle of wood from a cart used to transport the bundle into and/or out of the treatment vessel. The lift system vertically disengages the bundle of wood from the cart within the interior of the vessel, thereby allowing the cart to be removed from the vessel prior to initiating treatment. The lift system, which can be physically separate from or physically coupled to the cart, is entirely disposed within a lower portion of the interior volume of the wood treatment vessel.

### CROSS-REFERENCE TO RELATED APPLICATIONS

This application claims priority to U.S. Provisional Patent Application Nos. 61/581,268; 61/581,273; 61/581,271; 61/581,269; 61/581,266; 61/581,264, filed Dec. 29, 2011, the entireties of which are incorporated herein by reference to the extent not inconsistent with the present disclosure.

### FIELD OF THE INVENTION

This invention generally relates to wood treatment facilities and, in particular, to transportation systems utilized in wood treatment facilities.

### BACKGROUND

Because of its wide suitability for a variety of applications, its renewable nature, and its relatively low cost, wood is one of the most widely used materials in existence. However, because wood is a natural product, its physical and structural properties can vary substantially, not only amongst different species, but also amongst different trees, or even different locations within the same piece of wood. Furthermore, wood is hygroscopic, which affects its dimensional stability when exposed to moisture, and its composition makes it susceptible to attack by insects and fungi. As a result, several types of wood treatment processes have been developed to increase the stability of wood through modification of its chemical, physical, and/or structural properties. Examples of treatment processes include impregnation treatments, coating treatments, thermal modification, and chemical modification.

To date, widespread commercialization of facilities to chemically modify and/or thermally modify wood has not been achieved. The need for complex processing schemes and specialized equipment in these types of wood treatment facilities has made industrial-scale implementation both technically challenging and cost prohibitive. Further, rudimentary transportation systems, which typically employ push-carts or conveyor belts, are unable to achieve desirably low cycle times and are typically not suitable for exposure to challenging process environments, such as, for example, sub-atmospheric pressures, exposure to chemicals, and/or exposure to electromagnetic radiation.

Thus, a need exists for a commercial-scale wood treatment facility that includes a robust, yet efficient, wood transportation system. The transportation system should be suitable for use in a variety of challenging process environments and should facilitate minimal cycle times to thereby maximize both throughput and overall profitability of the facility.

### SUMMARY

One embodiment of the present invention concerns a system for treating wood. The system comprises a first wood treatment vessel for receiving at least one bundle of wood, wherein the first wood treatment vessel comprises a first door and a bundle transport system. The bundle transport system comprises a first cart for transporting the bundle of wood into and/or out of the first wood treatment vessel through the first door; and a lift system for vertically disengaging the bundle of wood from the first cart within the interior of the first wood treatment vessel.

Another embodiment of the present invention concerns a process for treating wood. The process comprises the steps of (a) introducing at least one bundle of wood into a first wood treatment vessel using a first cart, wherein the bundle of wood is supported on the first cart; (b) while the bundle of wood and the first cart are inside the first wood treatment vessel, removing the bundle of wood from the cart by vertically disengaging the bundle of wood from the cart; (c) while the bundle of wood is disengaged from the first cart and maintained inside the first wood treatment vessel, removing the first cart from the interior of the first wood treatment vessel; and (d) treating the bundle of wood in the first wood treatment vessel to thereby provide a treated bundle of wood.

### BRIEF DESCRIPTION OF THE DRAWINGS

Various embodiments of the present invention are described in detail below with reference to the attached drawing figures, wherein:

FIG. 1 is an isometric view of a wood treatment system configured in accordance with one embodiment of the present invention, particularly illustrating a bundle transport system for moving a bundle of wood into and/or out of a wood treatment vessel;

FIG. 2 is a vertical, longitudinal cross-section of a wood treatment vessel configured according to another embodiment of the present invention, particularly illustrating a bundle stabilization system for securing a bundle of wood during treatment within the vessel;

FIG. 3a is a vertical, transverse cross-section detailing the lower half of a wood treatment vessel according to one embodiment of the present invention, particularly illustrating a bundle support structure and a bundle of wood supported on a movable cart for introducing the bundle and bundle support structure into the interior of the wood treatment vessel;

FIG. 3b is a vertical, transverse cross-section detailing the lower half of the wood treatment vessel shown in FIG. 3a, particularly illustrating a lift system for vertically disengaging the bundle and bundle support structure from the cart within the interior of the vessel to thereby allow the cart to be removed from the vessel during treatment;

FIG. 4 is a isometric assembly view of a portion of a bundle transport system configured according to one embodiment of the present invention, particularly illustrating a cart drive system having at least one active drive component physically separate from the cart and at least one passive component physically coupled to the cart;

FIG. 5 is an isometric view of a wood treatment facility configured according to one embodiment of the present invention, showing the vessel broken away for clarity, particularly illustrating a bundle transport system including a movable transport segment shiftable to accommodate the opening and/or closing of the vessel entrance door;

FIG. 6 is a top view of a wood treatment facility configured according to yet another embodiment of the present invention, particularly illustrating a wood treatment facility employing two wood treatment vessels and a bundle transport system for moving wood within the multi-vessel facility;

FIG. 7 is an isometric view of a wood treatment facility configured according to another embodiment of the present invention, particularly showing a two-vessel facility utilizing a bundle transport shuttle;

FIG. 8 is an isometric assembly view of one embodiment of a bundle transport shuttle utilized in the wood treatment facility depicted in FIG. 7;

FIG. 9 is a vertical, transverse cross-section of the bundle transport shuttle depicted in FIG. 8;

FIG. 10a is a vertical, transverse cross-section detailing the lower half of a wood treatment vessel according to one embodiment of the present invention, particularly illustrating a bundle transport system comprising a lift system physically coupled to a cart for vertically disengaging a bundle within the interior of a wood treatment vessel;

FIG. 10b is a vertical, transverse cross-section detailing the lower half of the wood treatment vessel shown in FIG. 10a, particularly illustrating the cart lift system shown in FIG. 10a after the bundle and bundle support structure have been disengaged from the cart;

FIG. 11 is a top view of the wood treatment facility depicted in FIG. 7, particularly illustrating the movement of bundles of wood throughout the facility during treatment.

### DETAILED DESCRIPTION

In accordance with one or more embodiments of the present invention, a system for treating a load is provided. Load treatment systems configured according to embodiments of the present invention can include one or more treatment vessels and a transportation system operable to transport the load into, out of, and/or amongst various locations within the treatment facility. In one embodiment, the load treatment system of the present invention can comprise a wood treatment system operable to treat one or more bundles of wood. As used herein, the terms “treat” or “treatment” refer to any process, system, or step that alters at least one chemical, physical, and/or mechanical property of the load being treated (e.g., a bundle of wood).

The wood treated in the wood treatment systems described herein may be any species of hardwood or softwood. Examples of suitable wood species can include, but are not limited to, pine, fir, spruce, poplar, oak, maple, and beech. In one embodiment, the wood treatment system can treat at least one of the following species of wood: red oak, red maple, German beech, Pacific albus, or one or more of Radiata pine, Scots pine, Loblolly pine, Longleaf pine, Shortleaf pine, or Slash pine, the latter four of which can collectively be referred to as “Southern Yellow Pine” (SYP). Systems as described herein can also be operable to treat other types of lignocellulosic materials. Lignocellulosic materials can include any material comprising cellulose and lignin and, optionally, other materials, such as hemicelluloses. Examples of lignocellulosic materials can include, but are not limited, to wood, bark, kenaf, hemp, sisal, jute, crop straws, nutshells, coconut husks, grass and grain husks and stalks, corn stover, bagasse, conifer and hardwood barks, corn cobs, and other crop residuals, and any combination thereof.

The wood treatment systems described herein can be configured to treat wood in any physical form, including, for example, shredded wood, wood fibers, wood flour, wood chips, wood particles, wood flakes, wood strands, and wood excelsior. In one embodiment, the wood treated in the wood treatment system can comprise sawn timber, debarked tree trunks or limbs, boards, planks, veneers, beams, profiles, squared timber, or any other cut of lumber. In one embodiment, the wood may be solid wood, engineered solid wood, or a combination thereof. As used herein, the term “solid wood” refers to wood that measures at least about 10 centimeters in at least one dimensions but that is otherwise of any dimension, including those ranges provided below. As used herein, the term “engineered solid wood” refers to a wooden body having the minimum dimensions of solid wood (e.g., at least one dimension of at least about 10 cm), but that is formed of smaller bodies of wood and at least one binder. The smaller bodies of wood in engineered solid wood may or may not have one or more of the dimensions described below with respect to solid wood. Non-limiting examples of engineered solid wood can include wood laminates, fiberboard, oriented strand board, plywood, wafer board, particle board, and laminated veneer lumber.

When the wood being treated is cut into individual pieces, the lumber can generally be defined using two or more dimensions. The dimensions can be actual (e.g., “measured” dimensions) or can be nominal dimensions. As used herein, the term “nominal dimension” refers to the dimensions calculated using a size designation for the wood. For example, a dried “2×4” can have actual dimensions of 1.5 inches by 3.5 inches, but the nominal dimensions of “2×4” are still used. The nominal size can be smaller than, the same as, or larger than the measured dimensions. It should be understood that any dimensions referred to herein are generally nominal dimensions, unless otherwise noted.

In one embodiment, the wood can have three dimensions: a length, or longest dimension; a width, or second longest dimension; and a thickness, or shortest dimension. Each of the dimensions can be substantially the same, or at least one dimension can be different from one or more of the other dimensions. According to one embodiment, the length of the wood can be at least about 6 inches, at least about 1 foot, at least about 3 feet, at least about 4 feet, at least about 6 feet, or at least about 10 feet. In another embodiment, the width of the wood can be at least about 0.5 inches, at least about 1 inch, at least about 2 inches, at least about 4 inches, at least about 8 inches, at least about 12 inches, or at least about 24 inches and/or no more than about 10 feet, no more than about 8 feet, no more than about 6 feet, no more than about 4 feet, no more than about 3 feet, no more than about 2 feet, no more than about 1 foot, or no more than about 6 inches. In yet another embodiment, the thickness of the wood can be at least about 0.25 inches, at least about 0.5 inches, at least about 0.75 inches, at least about 1 foot, at least about 1.5 feet, or at least about 2 feet and/or no more than about 4 feet, no more than about 3 feet, no more than about 2 feet, no more than about 1 foot, and/or no more than about 6 inches.

Two or more pieces of wood can be arranged in a bundle having any suitable dimensions and/or shape. As used herein, the term “bundle” refers to two or more pieces of wood stacked, placed, or fastened together in any suitable manner. A bundle can comprise a plurality of boards stacked and coupled to one another via a belt, chain, polymeric strap, or other suitable device. In one embodiment, the boards or pieces of wood can be separated by spacers or “stickers,” while, in another embodiment, a majority of the boards can be in direct contact with each other. According to one embodiment, the bundle can have a total length, or longest dimension, of a least about 2 feet, at least about 4 feet, at least about 8 feet, at least about 10 feet, at least about 12 feet, at least about 16 feet, or at least about 20 feet and/or no more than about 60 feet, no more than about 40 feet, or no more than about 25 feet. The bundle can have a height, or second longest dimension, of at least about 1 foot, at least about 2 feet, at least about 4 feet, at least about 6 feet, at least about 8 feet, and/or no more than about 16 feet, no more than about 12 feet, no more than about 10 feet, no more than about 8 feet, no more than about 6 feet, or no more than about 4 feet. In one embodiment, the bundle can have a width, or shortest dimension, of at least about least about 1 foot, at least about 2 feet, at least about 4 feet, at least about 6 feet, and/or no more than about 20 feet, no more than about 16 feet, no more than about 12 feet, no more than about 10 feet, no more than about 8 feet, or no more than about 6 feet. The total volume of the bundle, including the spaces between the boards, if any, can be at least about 50 cubic feet, at least about 100 cubic feet, at least about 250 cubic feet, at least about 375 cubic feet, or at least about 500 cubic feet. The pre-treatment or initial weight of the bundle can be at least about 100 pounds, at least about 500 pounds, at least about 1,000 pounds, at least about 5,000 pounds, or at least about 10,000 pounds and/or the bundle of wood can have a cubical or cuboidal shape.

Various treatment systems configured according to embodiments of the present invention will now be discussed in detail below, with respect to the Figures. Although generally described herein with reference to the treatment of wood, it should also be understood that treatment systems according to embodiments of the present invention can be used to treat other materials, objects, or loads. For example, in one embodiment, treatment systems as described herein can be used to process or treat building or construction equipment materials such as tiles, bricks, concrete, composites, and the like; commercial or industrial processing equipment; transportation components, including aerospace equipment, as well as items such as food stuffs, pharmaceuticals, and glass. The treatment vessels utilized by one or more treatment systems described herein can include ovens, curing vessels, electroplating vessels, autoclaves, pressurizable vessels, vacuum vessels, and/or any vessel utilizing heat and/or other type of energy to alter the temperature of at least a portion of the load therein.

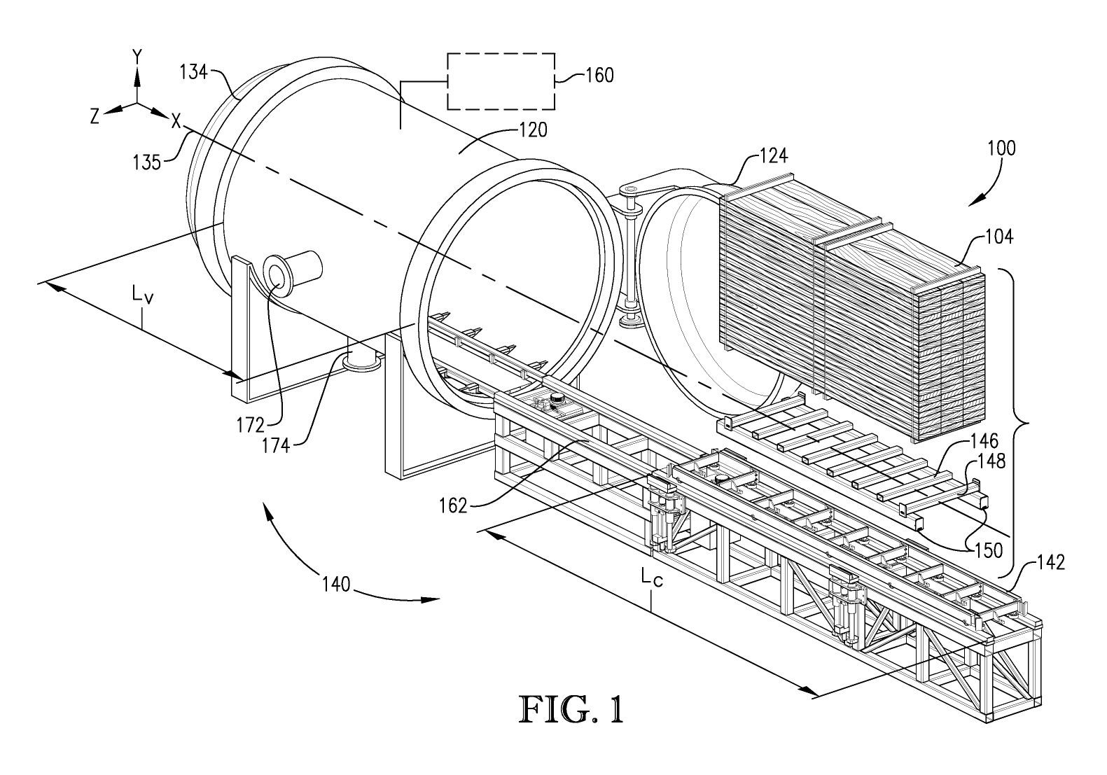

Turning initially to FIG. 1, a wood treatment system 100 configured according to one or more embodiments of the present invention is provided. Wood treatment system 100 comprises a wood treatment vessel (e.g., a first wood treatment vessel) 120 and a bundle transport system 140 for transporting at least one bundle of wood 104 into and/or out of the interior of first wood treatment vessel 120. Although illustrated in FIG. 1 as comprising a single wood treatment vessel, it should be understood that any suitable number of wood treatment vessels can be utilized in wood treatment system 100. Additional embodiments of the present invention including two or more wood treatment vessels will be discussed in detail shortly.

Wood treatment vessel 120 can be any vessel suitable for receiving and treating at least one bundle of wood. For example, in one embodiment, wood treatment vessel 120 can be a horizontally-elongated vessel having a circular or elliptical cross-section and defining a central axis of elongation, shown in FIG. 1 as line 135, extending substantially parallel to the horizontal (e.g., xy-plane) direction. As used herein, the term “substantially parallel” means within 10° of being parallel. Similarly, as used herein, the terms “substantially perpendicular” or “substantially horizontal” mean within 10° of being perpendicular or horizontal, respectively.

Wood treatment vessel 120 can define a maximum internal length and a maximum internal diameter. As used herein, the term “maximum internal length” refers to the largest dimension of a vessel, measured within the interior of the vessel, in a direction parallel to its axis of elongation. Examples of maximum internal lengths can include tangent-to-tangent (T/T) lengths, flange-to-flange lengths, and/or end-to-end lengths. In one embodiment, the maximum internal length of wood treatment vessel 120, shown generally as Lᵥ in FIG. 1, can be at least about 8 feet, at least about 12 feet, at least about 20 feet, or at least about 50 feet and/or no more than about 500 feet, no more than about 250 feet, or no more than about 100 feet. As used herein, the term “maximum internal diameter” refers to the largest dimension of a vessel, measured within the interior of the vessel, in a direction perpendicular to its axis of elongation. The maximum internal diameter of wood treatment vessel 120 can be at least about 3 feet, at least about 8 feet, or at least about 12 feet and/or no more than about 75 feet, no more than about 50 feet, no more than about 30 feet, or no more than about 25 feet. According to one embodiment, the ratio of the maximum internal length to the maximum internal diameter (e.g., L:D) of wood treatment vessel 120 can be at least about 2:1, at least about 4:1, or at least about 6:1 and/or no more than about 20:1, no more than about 16:1, or no more than about 12:1.

In one embodiment, wood treatment vessel 120 can be a pressurizable vessel. As used herein, the term “pressurizable” means able to be operated at pressures other than atmospheric. When wood treatment vessel 120 is pressurizable, wood treatment system 100 can optionally include a pressure adjustment system 160 for adjusting the pressure within the interior of wood treatment vessel 120. In one embodiment, pressure adjustment system 160 can be a vacuum system operable to reduce the pressure within wood treatment vessel 120 to a pressure of no more than about 500 torr, no more than about 350 torr, no more than about 250 torr, no more than about 200 torr, no more than about 100 torr, or no more than about 75 torr, using various equipment including, for example, a vacuum pump or other similar equipment. In another embodiment, pressure adjustment system 160 can be operable to increase the pressure within the interior of wood treatment vessel 120 to a pressure of at least about 1,000 torr, at least about 2,000 torr, at least about 2,500 torr, or at least about 3,000 torr. According to one embodiment, pressure adjustment system 160 can be operable to both increase and reduce the pressure within wood treatment vessel 120 above and below atmospheric pressure during treatment carried out within vessel 120.

When wood treatment vessel 120 comprises a pressurizable vessel, it may also include one or more doors for at least partially sealing the interior of the vessel during treatment to thereby maintain a desired operating pressure. In one embodiment shown in FIG. 1, wood treatment vessel 120 can include a first entrance door 124 for permitting and blocking access into the interior of wood treatment vessel 120. Depending on the specific treatment process carried out within wood treatment vessel 120, first entrance door can also include a fluid seal and/or energy choke (not shown in FIG. 1) in order to maintain specific operating conditions within wood treatment vessel 120. According to one embodiment, wood treatment vessel 120 can optionally include a separate exit door, illustrated as a first exit door 134 in FIG. 1, which can be located on a generally opposite end of wood treatment vessel 120 from first entrance door 124. In another embodiment, first entrance door 124 (e.g., first door or reactor door) may be the only door for transporting a load (e.g., bundle of wood) into and out of wood treatment vessel 120.

Wood treatment vessel 120 can be used to carry out any suitable type of wood treatment process. For example, in one embodiment, wood treatment vessel 120 can be used to produce thermally-modified wood and/or chemically-modified wood. In the same or another embodiment, wood treatment vessel can comprise a wood heater and/or wood dryer for heating and/or drying previously treated or untreated wood. In one embodiment, wood treatment vessel 120 can be a thermal modification vessel used to thermally modify wood. As used herein, the term “thermally modify” means to alter the chemical structure of at least a portion of the wood in the absence of an exogenous treating agent. During thermal modification, the wood can be contacted with one or more heat transfer agents, such as, for example, steam, heated inert vapors like nitrogen or air, and even various types of liquid heat transfer media such as heated oil to heat the wood and alter its properties. Radiant or convective heat may be used during thermal modification. As a result of thermal modification, the wood can have a lower moisture content and enhanced physical and/or mechanical properties, including increased flexibility, higher resistance to decay and biological attacks, and/or increased dimensional stability.

In another embodiment of the present invention, wood treatment vessel 120 can be a chemical modification vessel (or chemical modification reactor or chemical treatment vessel) used to chemically modify wood. As used herein, the term “chemically modify” means to alter the chemical structure of at least a portion of the wood in the presence of one or more exogenous treating agents. Specific types of chemical modification processes can include, but are not limited to, acetylation and other types of esterification, epoxidation, etherification, furfurlyation, methylation, and/or melamine treatment. Non-limiting examples of suitable treatment agents can include anhydrides (e.g., acetic, phthalic, succinic, maleic, propionic, or butyric); acid chlorides; ketenes; carboxylic acids; isocyanates; aldehydes (e.g., formaldehyde, acetyldehyde, or difunctional aldehydes); chloral; dimethyl sulfate; alkyl chlorides; beta-propiolacetone; acrylonitrile; epoxides (e.g., ethylene oxide, propylene oxide, or butylenes oxides); difunctional epoxides; borates; acrylates; silicates; and combinations thereof. Although not wishing to be bound by theory, it is hypothesized that the chemical modification agent reacts with at least a portion of the surface functional groups (e.g., hydroxyl groups) of the untreated wood to thereby provide chemically-modified wood. As a result of the chemical modification, the treated wood can have a lower moisture content, higher dimensional stability, enhanced biological, pest, and decay resistance, and better mechanical properties than similar untreated wood.

In one embodiment of the present invention, wood treatment vessel 120 can be an acetylation reactor. As used herein, the term “acetylation” refers to a chemical modification process in which at least a portion of the surface hydroxyl groups of the wood are replaced with acetyl groups. The treatment agent employed during acetylation can comprise at least about 50 weight percent, at least about 60 weight percent, at least about 75 weight percent, at least about 90 weight percent, or at least about 98 weight percent acetic acid, with the balance comprising acetic anhydride, one or more diluents, and/or optional catalysts. In one embodiment, the acetylation treatment agent can comprise acetic acid and acetic anhydride in a weight ratio of at least about 80:20, at least about 85:15, at least about 90:10, or at least about 95:5.

Prior to acetylation, the wood can be dried to reduce its moisture (e.g., water) content to no more than about 25 weight percent, no more than about 20 weight percent, or no more than about 15 weight percent using kiln drying, vacuum degassing, or another suitable method. During the acetylation process, the wood can be contacted with the acetylation reagent, as discussed above, via vapor contacting, spraying, liquid immersion, or combinations thereof. In one embodiment, a liquid acetylation reagent can be introduced into the interior of the reactor (e.g. wood treatment vessel 120) via a liquid inlet port, shown generally as inlet 172 in FIG. 1, to at least partially submerge the bundle in the liquid reagent within the interior of wood treatment vessel 120. According to one embodiment, the average temperature within the interior of the acetylation reactor while the treatment agent is present can be no more than about 50° C., no more than about 40° C., or no more than about 30° C., while the pressure can be at least about 25 psig, at least about 50 psig, at least about 75 psig and/or no more than about 500 psig, no more than about 250 psig, or no more than about 150 psig.

Once the contacting step is complete, at least a portion of the liquid treatment agent, if present, can be drained or otherwise removed from the acetylation reactor via an outlet (e.g. drain) port, shown as outlet 174 in FIG. 1, and heat from a heat source can be added to the reactor to initiate and/or catalyze the reaction. Any suitable heat source can be used, including, for example, microwave energy, thermal energy, or combinations thereof, in order to increase the temperature of the wood to at least about 50° C., at least about 65° C., at least about 80° C. and/or to no more than about 175° C., no more than about 150° C., or no more than about 120° C., while maintaining a pressure of at least about 750 torr, at least about 1,000 torr, at least about 1,200 torr, or at least about 2,000 torr and/or no more than about 7,700 torr, no more than about 5,000 torr, no more than about 3,500 torr, or no more than about 2,500 torr. According to one embodiment, at least a portion of the heat added to the reactor can be transferred from a hot vapor stream comprising at least about 50 weight percent, at least about 75 weight percent, at least about 90 weight percent, or at least about 95 weight percent acetic acid, with the balance comprising acetic anhydride and/or diluents. The contact time of the hot vapor stream with the bundle can be at least about 20 minutes, at least about 35 minutes, at least about 45 minutes and/or no more than about 180 minutes, no more than about 150 minutes, or no more than about 120 minutes.

After the reaction step, the chemically-modified wood can comprise at least one chemical component capable of being removed by heat and/or vaporization. For example, when wood is acetylated, at least a portion of the residual acetic acid or anhydride can be removed by vaporization. In one embodiment, the acid-wet wood resulting from a chemical modification step carried out in wood treatment vessel 120 can comprise at least about 20 weight percent, at least about 30 weight percent, at least about 40 weight percent, or at least about 45 weight percent acid and/or no more than about 75 weight percent, no more than about 60 weight percent, or no more than about 50 weight percent of one or more vaporizable chemicals, such as, for example, acetic acid and/or anhydride.

After chemical treatment, a flash drying step can be carried out in wood treatment vessel 120 subsequent to the contacting and heating steps described previously in order to vaporize, or flash, at least a portion of one or more vaporizable chemicals from the acid-wet wood. In one embodiment, the flash vaporization step can be accomplished by reducing the pressure in the reactor from a pressure of at least about 1,000 torr, at least about 1,200 torr, or at least about 2,000 torr and/or no more than about 7,700 torr, no more than about 5,000 torr, no more than about 3,500 torr, or no more than about 2,500 torr to atmospheric pressure. In another embodiment, the flash vaporization step can be accomplished by reducing the pressure of the reactor from an elevated pressure, as described above, or atmospheric pressure, to a pressure of no more than about 100 torr, no more than about 75 torr, no more than about 50 torr, or no more than about 35 torr. The amount of one or more vaporizable components (e.g., acetic acid and/or acetic anhydride) remaining in the acetylated or chemically-modified wood after the flash vaporization step can be at least about 6 weight percent, at least about 8 weight percent, at least about 10 weight percent, or at least about 12 percent and/or no more than about 25 weight percent, no more than about 20 weight percent, or no more than about 15 weight percent.

When wood treatment vessel 120 comprises an acetylation reactor, a chemical modification reactor, or any other type of treatment vessel in which wood is contacted with a liquid reagent, wood treatment system 100 can also comprise a stabilization system for securing the bundle of wood or other load within the interior of the wood treatment vessel before, during, and/or after treatment with a liquid reagent. In one embodiment, the bundle stabilization system may be used to overcome the buoyant forces present when the bundle of wood (or other load) is at least partially, or entirely, submerged in a liquid reagent. In another embodiment, the bundle stabilization may be used to secure the bundle of wood in place and/or maintain its shape, even when no liquid reagent is present within the wood treatment vessel.

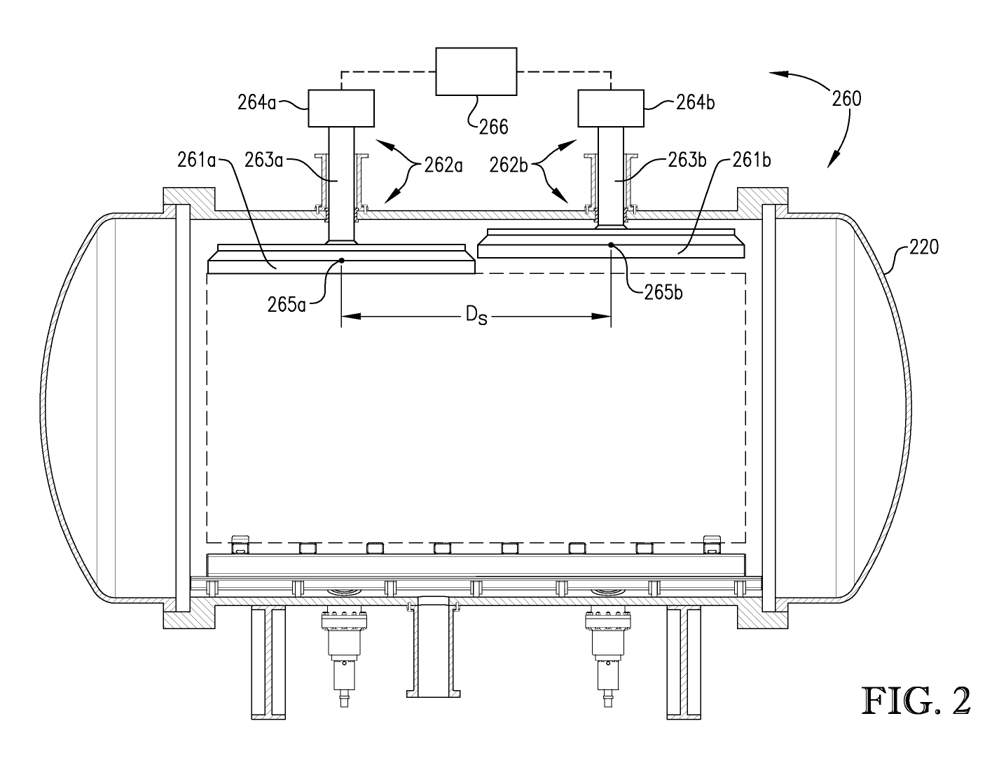

One embodiment of a bundle stabilization system 260 is illustrated in FIG. 2 as comprising two bundle hold-down devices 262a,b and two drivers 264a,b for respectively adjusting the position of bundle hold-down devices 262a,b within the interior of wood treatment vessel 220. Bundle stabilization system 260 can also include an automatic control system 266 for regulating the movement and/or position of drivers 264a,b and/or hold-down devices 262a,b. Each of drivers 264a,b can be operable to adjust the position of bundle hold-down devices 262a,b and can be an electric driver, a pneumatic driver, or a hydraulic driver. Control system 266 can be configured to automatically control drivers 264a,b and/or bundle hold-down devices 262a,b to accommodate changes in one or more dimensions of the bundle during treatment. When bundle hold-down devices 262a,b are independently movable with respect to one another, each of drivers 264a,b can be separately automatically controlled by control system 266 when accommodating such changes.

According to one embodiment depicted in FIG. 2, bundle hold-down devices 262a,b can be disposed in the upper one-half, the upper one-third, or the upper one-fourth of the internal volume of wood treatment vessel 220 such that bundle hold-down devices 262a,b are movable within the interior of wood treatment vessel 220 to secure the bundle of wood. Unlike ties, ropes, or other conventional securing devices, bundle hold-down devices 262a,b are not physically coupled to the bundle of wood or to the cart (not shown in FIG. 2) used to transport the wood into wood treatment vessel 220. Rather, bundle hold-down devices 262a,b may be coupled to at least one wall of wood treatment vessel 220, as shown in FIG. 2.

Each of bundle hold-down devices 262a,b can comprise a respective securing surface 261a,b operable to contact at least a portion of the upper surface of the bundle of wood when the bundle is disposed within the interior of wood treatment vessel 220. In one embodiment, each securing surface 261a,b can comprise a substantially flat, non-electrode contact surface configured to contact and exert a downward force on at least a portion of the upper surface of the bundle of wood. In one embodiment, securing surfaces 261a,b can be oriented such that at least about 50 percent, at least about 80 percent, or at least about 95 percent of each securing surface 261a,b contacts the upper surface of the bundle. In another embodiment, at least a portion of securing surfaces 261a,b can be contoured such that only a small portion of securing surfaces 261a,b can contact the upper surface of the bundle of wood. For example, each of securing surfaces 261a,b can comprise one or more projections (not shown in FIG. 2) operable to contact and secure the bundle of wood and no more than about 40 percent, no more than about 30 percent, no more than about 20 percent, or no more than about 15 percent of the total area of each of securing surfaces 261a,b can contact the upper surface of the bundle.

When bundle stabilization system 260 comprises a plurality of bundle hold-down devices, each securing surface 261a,b of each bundle hold-down device 262a,b can be spaced from each other by a suitable distance. For example, in one embodiment, each of surfaces 261a,b can define a respective center point 265a,b, located at the geometric or volumetric center of each surface 261a,b. According to one embodiment wherein bundle stabilization system comprises two or more securing surfaces 261a,b, the distance between the center points 265a,b of adjacent securing surfaces, shown as Dₛ in FIG. 2, can be no more than about 25 feet, no more than about 15 feet, no more than about 10 feet, or no more than about 5 feet.

As shown in FIG. 2, each of bundle hold-down devices 262a,b can also include at least one movable arm 263a,b for controlling the position of respective securing surfaces 261a,b within the interior of wood treatment vessel 220. Movable arms 263a,b can be operable to retract and extend securing surfaces 261a,b within the interior of wood treatment vessel 220 in a radially inward and/or a radially outward direction, toward and/or away from the central axis of elongation 235 of wood treatment vessel 220 (or a plane parallel thereto, not shown in FIG. 2). As used herein, the term “radial direction” or “radially” means in a direction extending from an outer surface of the vessel toward the central point or axis of the vessel. According to one embodiment, bundle hold-down devices 262a,b can utilize movable arms 263a,b to exert a radially inward (or downward) force from an upper wall of wood treatment vessel 220 to the upper surface of the bundle of wood (not shown in FIG. 2) to thereby secure the bundle 204 within the interior of the vessel 220 during at least a portion of its treatment.

When bundle stabilization system 260 comprises two or more bundle hold-down devices, as illustrated in FIG. 2, both bundle hold-down devices 262a,b can be configured to move synchronously. In another embodiment, each of the hold-down devices 262a,b can be independently movable with respect to one another. As used herein, the term “independently movable” means able to move or change position without the influence of another external object or item. When bundle hold-down devices 262a,b are independently movable with respect to one another, one of the devices 262a or 262b can be operable to move in a certain manner (e.g., up or down to a certain degree), while the other device 262b or 262a does not move or moves in a different manner (e.g., up or down to a greater or lesser degree). Utilizing independently movable bundle hold-down devices may be advantageous, for example, when one or more dimensions of the load or bundle being treated may possibly change in an unpredictable or inconsistent manner at any time during treatment, including, for example, before, during, and/or after at least partial submersion in a liquid reagent. As the dimensions of the bundle change and/or as the bundle begins to shift position, bundle stabilization system 260 can be configured to automatically adjust the position of one or more of bundle hold-down devices 262a,b in order to stabilize the bundle of wood in substantially the same position or shape and/or to prevent the bundle from floating upwardly, if partially or entirely submerged in a liquid reagent. Bundle stabilization system 260 can be configured to carry out such adjustments even when no liquid reagent is present in wood treatment vessel 220, including in systems and processes wherein no liquid reagent is even employed.

In operation, a bundle of wood (not shown) can be introduced into the interior of wood treatment vessel 220 using, for example, a first cart (also not shown). Once inside, the bundle of wood may be secured within the interior of vessel 220 by contacting at least a portion of the upper surface of the bundle with one or more securing surfaces 261a,b of bundle hold-down devices 262a,b. Contact may be initiated by moving one or more of securing surfaces 261a,b in a radially inward (downward) direction using movable arms 263a,b driven by drivers 264a,b. In one embodiment, the maximum force exerted between the bundle and securing surfaces 261a,b and/or bundle hold-down devices 262a,b can be no more than about 200 pounds per square inch (psi), no more than about 100 psi, no more than about 50 psi, or no more than about 30 psi, measured at the point of contact between bundle securing surfaces 261a,b and the surface of the bundle of wood. Forces within these ranges may be sufficient to secure the bundle, while minimizing or preventing damage to the wood.

In one embodiment, after the bundle has been secured, a liquid reagent (if used) can be introduced into the interior of vessel 220 via one or more liquid inlets (not shown) to thereby at least partially, or entirely, submerge the bundle of wood in the liquid reagent. As the liquid contacts the wood, it can be at least partially absorbed into the bundle, thereby causing the bundle to change dimension (e.g., expand). Additionally, as the liquid surrounds the bundle within the interior of wood treatment vessel 220, the buoyant forces exerted on the bundle may also cause it to start to shift position within vessel 220. Depending, in part, on the size of the bundle, the buoyant forces exerted on the bundle within wood treatment vessel 220 may be at least about 10,000 pounds, at least about 15,000 pounds, at least about 20,000 pounds, or at least about 30,000 pounds. Even when no liquid reagent is present in wood treatment vessel 220, bundle stabilization system can be used to adjust the position of at least one bundle hold-down device 262a,b to secure the bundle in place during treatment.

In operation, the process of adjusting bundle stabilization system 260 to accommodate changes in the bundle dimensions and/or position can be carried out by first measuring a value for one or more parameters of the system, such as, for example, the force exerted between the bundle hold-down devices 262a,b and/or securing surfaces 261a,b and the bundle. Thereafter, based at least in part on the measured value obtained, the position of one or more of bundle hold-down devices 262a,b may be altered via drivers 264a,b and/or control system 266. As the positions of the bundle hold-down devices change, the value for the measured parameter may also change and bundle hold-down devices 262a,b can continued to be repositioned until the measured value falls within a pre-determined target range for that parameter.

For example, in one embodiment, the measured parameter may be the force exerted between the bundle hold-down devices 262a,b and/or securing surfaces 261a,b and the surface of the bundle. If, upon measurement of a value for this parameter, it is determined that the force between the bundle hold-down devices 262a,b and the bundle is lower than a pre-determined minimum lower threshold value, bundle stabilization system 260 can be configured to automatically extend (e.g., move in a radially-inward direction) at least one of bundle hold-down devices 262a,b via control system 266. If it is determined that the force between the bundle hold-down devices 262a,b and the bundle is higher than a pre-determined maximum upper threshold value, bundle stabilization system 260 can be configured to automatically retract (e.g., move in a radially-outward direction) at least one of bundle hold-down devices 262a,b using automatic control system 266. Such a process of measuring a parameter and adjusting the position of one or more bundle hold-down devices 262a,b can be continued until a value within the target limits (e.g., below the maximum upper threshold value and/or above a minimum lower threshold value) is achieved. In one embodiment, the above-described process of measuring a bundle parameter and adjusting the position of at least a portion of bundle stabilization system 260 may be carried out at any time before, during, and/or after the introduction of a liquid reagent into wood treatment vessel 220 and/or in a treatment process in which no liquid reagent is utilized.

Turning back to FIG. 1, in another embodiment of the present invention, wood treatment vessel 120 can be a wood heater and/or wood dryer. As used herein, the term “heat” means to increase the temperature of at least a portion of an object, item, or space, and the term “dry” means to remove at least a portion of one or more liquid or otherwise vaporizable components from an object or item. In one embodiment, wood treatment vessel 120 can be both a heater and a dryer. In another embodiment, vessel 120 can be a vacuum heater and/or a vacuum dryer. When wood treatment vessel 120 comprises a heater and/or dryer, any suitable source of radiant, convective, and/or conductive energy for heating and/or drying wood may be used. In one embodiment, wood treatment vessel 120 can be a microwave heater such that at least about 50 percent, at least about 75 percent, at least about 90 percent, or substantially all of the energy required to heat and/or dry the wood within the interior of vessel 120 can be microwave energy having a frequency between 300 MHz and 30 GHz. When wood treatment vessel 120 is a microwave heater, it can additionally comprise one or more internal devices (e.g., reflectors, launchers, etc.) for emitting, discharging, and/or dispersing the energy into the interior of vessel 120 (none shown in FIG. 1). Additional embodiments of a wood treatment facility employing a wood heater and/or dryer will be discussed in detail shortly.

Wood treatment system 100 depicted in FIG. 1 also comprises a bundle transport system 140 operable to move a bundle of wood 104 into, out of, and/or between various locations within the wood treatment facility. Bundle transport system 140 can comprise at least one cart 142 for transporting at least one bundle of wood 104 into and/or out of wood treatment vessel 120 along a transport segment 162, illustrated in FIG. 1 as a rail segment 162. As shown in FIG. 1, at least a portion of the transport segment along which cart 142 is configured to travel may be substantially parallel to the axis of elongation 135 of wood treatment vessel 120 such that the cart may be at least partially introduced into the interior of wood treatment vessel 120 during loading and/or unloading of bundle 104. Additional details regarding various embodiments of cart 142 and transport segment 162 will be discussed in detail shortly.

Bundle transport system 140 can also comprise at least one bundle support structure 146 for at least partially supporting bundle of wood 104. In one embodiment, bundle support structure 146 can include a continuous, flat plate-like surface supported on two or more longitudinal supports (not shown in FIG. 1), while, in another embodiment, bundle support structure 146 can include a plurality of cross-member supports 148 oriented perpendicularly to two longitudinal support members 150a,b, as depicted in FIG. 1. Bundle support structures configured according to other embodiments of the present invention will be discussed in detail shortly.

Although shown in FIG. 1 as supporting a single bundle of wood 104, it should be understood that bundle support structure 146 can be configured to support any suitable number of bundles, including at least 2, at least 3, or at least 5 bundles of wood and/or no more than 10, no more than 8, or no more than 6 bundles of wood. Further, in the same or another embodiment, cart 142 can be also be configured to support multiple bundle support structures, including, for example, at least 2, at least 3, at least 5 bundle support structures and/or no more than 10, no more than 8, or no more than 6 bundle support structures. In one embodiment, cart 142 can be configured to support two or more bundle support structures, which may also, in turn, each be configured to support two or more bundles of wood. The size and/or number of bundle support structures utilized by wood treatment facility 100 may vary according to several operational and/or design factors.

In order to support the weight of one or more typically large bundles of wood, bundle support structure 146 can be substantially rigid and have enhanced strength, especially in comparison to traditional wooden pallets. For example, in one embodiment, bundle support structure 146 can have a distributed weight capacity of at least about 500 pounds, at least about 1,000 pounds, at least about 2,000 pounds, at least about 5,000 pounds, or at least about 10,000 pounds. As used herein, the term “distributed weight capacity” of a structure refers to the maximum amount of evenly distributed weight able to be supported by the structure without significant bending, breaking, or other deformation, measured when the structure is supported only at its corners or edges.

Bundle support structure 146 can also be substantially robust, such that it can be exposed to a variety of process conditions without being damaged or without causing significant operational problems. For example, in one embodiment, bundle support structure 146 can be corrosion-resistant, such that it can be exposed to process conditions including high temperatures (e.g., above 100° C.) and/or low pHs (e.g., a pH of 5 or below at room temperature) without experiencing accelerated corrosion rates (e.g., rates greater than 10 mils per year, mpy). In another embodiment, bundle support structure 146 can be microwave compatible, such that it can be exposed to microwave energy without substantial arcing. As used herein, the term “arcing” refers to undesired, uncontrolled electrical discharge, at least partially caused by ionization of a surrounding fluid.

Bundle support structure can be formed of any suitable material and can have a size and/or shape as required to support the required quantity of wood. Examples of suitable materials of construction for bundle support structure 146 include, but are not limited to, one or more metals or metal alloys including, for example, selected carbon steels, stainless steels, nickel alloys, aluminum alloys, and/or copper alloys. In one embodiment, bundle support structure 146 can have a length of at least about 2 feet, at least about 4 feet, at least about 8 feet, at least about 12 feet, or at least about 16 feet and/or no more than about 150 feet, no more than about 100 feet, no more than about 75 feet, or no more than about 50 feet and/or can have a width of at least about 1 foot, at least about 2 feet, at least about 3 feet, or at least about 4 feet and/or no more than about 40 feet, no more than about 20 feet, no more than about 16 feet, or no more than about 10 feet. According to one embodiment, the ratio of the length of bundle support structure 146 to the length of cart 142 is at least about 0.35:1, at least about 0.45:1, or at least about 0.55:1 and/or no more than about 0.99:1, no more than about 0.90:1, or no more than about 0.85:1. According to one embodiment, bundle support structure 146 may be an adjustable structure, configured to be lengthened or shortened based on the number and/or length of bundles being supported.

According to one embodiment, bundle support structure 146 may not be independently movable and, consequently, may be at least partially supported on cart 142 during transportation of bundle 104 into and/or out of wood treatment vessel 120. In one embodiment, bundle support structure 146 and cart 142 may be configured such that at least about 50 percent, at least about 60 percent, at least about 75 percent, at least about 80 percent, at least about 90 percent, at least about 95 percent, or substantially all of the total weight of bundle 104 and/or bundle support structure 146 are supported on an upper surface of cart 142. In one embodiment, bundle support structure 146 can be detachably or removably coupled to cart 142, such that the removal of bundle support structure 146 does not cause substantial damage to bundle 104, bundle support structure 146, and/or cart 142 when bundle 104 and bundle support structure 146 are removed from cart 142. When bundle support structure 146 comprises a detachable bundle support structure, in one embodiment, the bundle of wood may be coupled, via a polymeric strap or other suitable fastening device, to bundle support structure 146, and may be supported on, but not coupled to, cart 142. In another embodiment, bundle 104 may be fastened together with a suitable fastener, but may not be coupled to either bundle support structure 146 or cart 142.

Bundle support structure 146 and cart 142 can be shiftable between a transport configuration, wherein bundle support structure 146 is supported on cart 142 as described above, and a treatment configuration, wherein bundle support structure 146 is not supported on cart 142. Transitions between the transport and treatment configurations can be carried out within the interior of wood treatment vessel 120, for example, to load and/or unload bundle 104 and bundle support structure 146 onto and/or off of cart 142. In one embodiment, bundle of wood 104 can be loaded onto bundle support structure 146 when bundle support structure 146 and cart 142 are configured in a transport configuration, as generally depicted in the assembly view of FIG. 1. As bundle 104 is moved along transport path 162 and into wood treatment vessel 120 via first door 124, bundle support structure 146 and cart 142 can remain in the transport configuration. Once inside vessel 120, bundle 104 may be removed from bundle support structure 146 and cart 142 may then be shifted to a treatment configuration by utilizing a transition or lift system (not shown in FIG. 1) operable to vertically decouple or disengage bundle 104 and bundle support structure 146 from cart 142 within the interior of vessel 120. Thereafter, cart 142 can be withdrawn from the interior of vessel 120 while bundle 104 and bundle support structure 146 remain within vessel 120 for treatment.

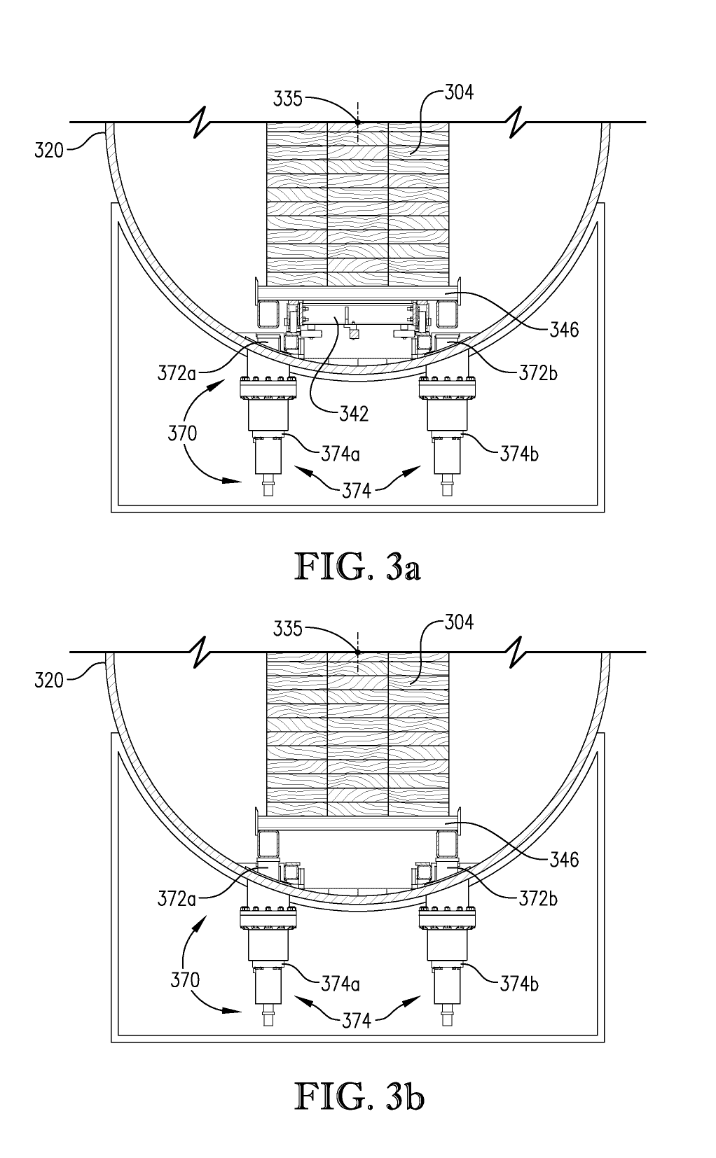

Referring now to FIGS. 3a and 3b, one embodiment of a lift system 370 suitable for use in a wood treatment vessel 320 is shown. Lift system 370 is capable of vertically disengaging bundle 304 (and bundle support structure 346) from cart 342 within the interior of wood treatment vessel 320 by extending and/or retracting at least a portion of lift system 370 toward and/or away from central axis of elongation 335 of wood treatment vessel 320. In one embodiment, lift system 370 can be configured to disengage bundle 304 from cart 342 within the interior of wood treatment vessel 320 by transitioning bundle 304 and bundle support structure 346 between a transport configuration, as illustrated in FIG. 3a, and a treatment configuration, wherein bundle 304 and bundle support structure 346 are not supported on cart 342 as illustrated in FIG. 3b. Lift system 370 can also be operable to facilitate removal of bundle 304 and bundle support device 346 from the interior of wood treatment vessel 320 by reconfiguring (vertically repositioning) bundle 304 and bundle support device 346 to be supported on cart 342 (e.g., load bundle 304 and bundle support device 346 onto cart 342). Such a transition can be carried out by shifting lift system 370 from a treatment configuration shown in FIG. 3b to a transport configuration shown in FIG. 3a and removing the loaded cart 342 from wood treatment vessel 320.

According to one embodiment, at least a portion of lift system 370 can be positioned in the lower portion of wood treatment vessel 320, such that lift system 370 is at least partially, or entirely, located in the lower one-half, lower one-third, or lower-one fourth of the interior volume of wood treatment vessel 320, as depicted in one embodiment shown in FIGS. 3a and 3b. Lift system 370 may be physically separate from cart 342 and can optionally be physically and/or permanently coupled to one or more walls of wood treatment vessel 320. According to another embodiment (not shown in FIGS. 3a and 3b), at least a portion of lift system 370 may be removable from the interior of wood treatment vessel, such that lift system 370 is disposed within the interior of wood treatment vessel 320 during the vertical disengagement from cart, but not during treatment of bundle 304. Additional embodiments of a removable lift system will be discussed in detail shortly.

Referring again to FIGS. 3a and 3b, lift system 370 can comprise one or more extensible support arms 372a,b for contacting and changing the vertical position of bundle support device 346 (and/or bundle 304) within vessel 320 and a support arm drive system 374 operable to extend and/or retract support arms 372a,b into and/or out of the interior of wood treatment vessel 320. Lift system 370 can include any number of extensible support arms and, in one embodiment, can include at least 3, at least 4 or at least 5 extensible support arms and/or no more than about 30, no more than about 20, no more than about 10, no more than about 8, or no more than about 6 extensible support arms spaced at appropriate intervals along the length of wood treatment vessel 320. Depending, in part, on the number of bundles of wood treated within vessel 320, lift system 370 can include at least 2, at least 3, at least 4, or at least 6 and/or no more than 10, no more than 8, or no more than 6 extensible arms per bundle treated within the interior of vessel 320. Support arm drive system 374 can include at least one driver, shown in FIGS. 3a and 3b as hydraulic drivers 374a, 374b, operably coupled to one or more of extensible support arms 372a,b and operable to move support arms 372a,b in a generally inward (upward) and/or downward (outward) direction. In another embodiment, drivers 374a,b can be pneumatic drivers. The operation of lift system 370 illustrated in the embodiments depicted in FIGS. 3a and 3b will now be described in detail below.

As generally shown in FIG. 3a, bundle of wood 304 can loaded onto bundle support structure 346 and introduced into the interior of wood treatment vessel 320 via cart 342, as described previously with respect to FIG. 1. Once inside the interior of the vessel 320, lift system 370 can be operated such that one or more of extensible support arms 372a,b can be moved upwardly and in an inward direction, until an upper portion of support arms 372a,b contacts a lower portion of bundle support structure 346. Thereafter, support arms 372a,b can continue to move upwardly thereby lifting bundle 304 and bundle support structure 346 off of cart 342 in a substantially vertical direction (e.g., a direction substantially perpendicular to the axis of elongation 335 of wood treatment vessel 320) toward the axis of elongation 335 of vessel 320 until bundle 304 and bundle support structure 346 are completely decoupled (e.g., not in contact with) cart 342. Subsequently, cart 342 can be removed from the interior of wood treatment vessel 320 the vessel and bundle support structure 346 can remain supported by extensible support arms 372a,b for the duration of the treatment (e.g., in the absence of cart 342), as shown in FIG. 3b. In another embodiment (not shown in FIGS. 3a and 3b), after cart 342 has been removed, bundle 304 and bundle support structure 346 can be lowered onto a stationary vessel support (not shown in FIG. 3a or 3b) located within the interior of wood treatment vessel 320 and can remain there for the duration of treatment.

Lift system 370 can also be used to load or transfer a treated bundle onto cart 342 after treatment in order to remove or unload the treated bundle. For example, in one embodiment, once the treatment of bundle 304 has been completed, an empty cart 342 (or another cart, not shown) may be introduced into the interior of wood treatment vessel 320. Once in the vessel, lift system 370 may be used to transfer the treated bundle onto cart 342 by lifting the treated bundle of wood 304 and bundle support structure 346 in a substantially vertical direction toward the central axis of elongation 335 of wood treatment vessel 320. This can be carried out by, for example, extending one or more extensible support arms 372a,b of lift system 370 in an upward direction toward axis of elongation 335. In the same or another embodiment, the transferring may also include lowering the treated bundle 304 in a substantially vertical direction away from the central axis of elongation 335 of wood treatment vessel 320 by, for example, lowering one or more of extensible support arms 372a,b, to thereby contact (or re-couple) bundle 304 and/or bundle support structure 346 with cart 324. Thereafter, treated bundle 304 and bundle support structure 346 may be withdrawn from wood treatment vessel 320 with cart 342.

In one embodiment, lift system 370 can further include a weight-sensing mechanism, such that the weight of bundle 304 can be measured, either directly or indirectly, at any time during loading, unloading, and/or treatment of the bundle. Bundle weights obtained before, during, and/or after treatment can be used for a variety of objectives. For example, bundle weight measurements can be used to determine the end of an impregnation cycle (when treatment vessel 320 comprises a chemical treatment vessel) or the end of a drying cycle (when treatment vessel 320 comprises a chemical treatment vessel and/or a wood heater). In one embodiment, bundle weights measured with a weight-sensing mechanism associated with lift system 370 can be used to adjust one or more other operating parameters including, for example, vessel temperature, vessel pressure, and/or cycle end point.

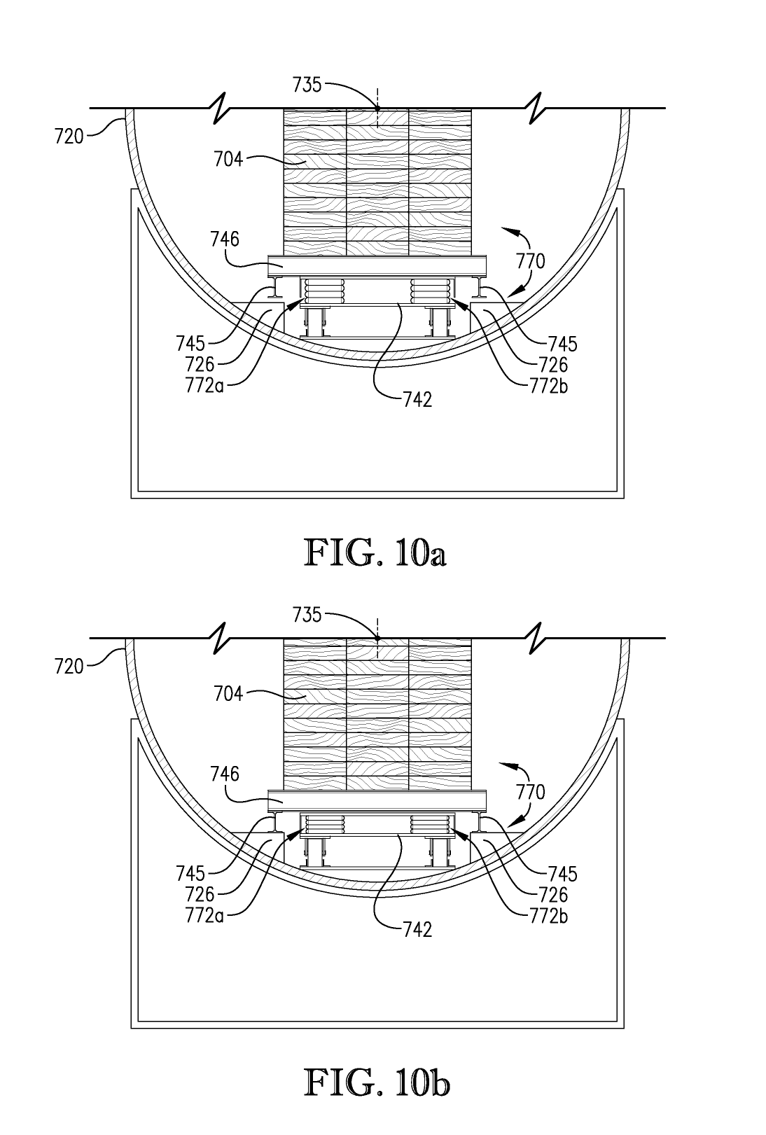

In one embodiment, at least a portion of the weight sensing mechanism can be incorporated into or associated with one or more support arms 372a,b and/or one or more of drivers 374a,b. After the treatment has been completed, cart 342 can be reintroduced into the interior of vessel 320 and the treated bundle 304 and bundle support structure 346 can be lowered back onto cart 342 using lift system 370, in a reverse manner as described in detail above. Lift system 370 may be used to lift bundle 304 prior to reintroducing cart 342 into the interior of vessel 320, depending on the location of the stationary support structure (if used) and/or the position of extensible support arms 372a,b during treatment. Once cart 342 has been loaded with treated bundle 304 and bundle support structure 346, extensible arms 372a,b can be fully retracted and cart 342, along with bundle 304 and bundle support structure 346, can be removed from the interior of vessel 320. Another embodiment of a lift system will be discussed in detail shortly with respect to FIGS. 10a and 10b.

Turning again to FIG. 1, cart 142 of wood treatment facility 100 can be configured to transport bundle 104 and bundle support structure 146, when present, into, out of, and/or amongst various locations of wood treatment facility 100. In one embodiment, cart 142 can be an externally driven cart. As used herein, the term “externally driven” refers to a movable object or item receiving a substantial portion of its motive force from a source to which the object is not permanently physically coupled. In the same or another embodiment, cart 142 can comprise an untethered cart. As used herein, the term “untethered” means able to move without the aid of hydraulic, pneumatic, electrical, mechanical, or fiber optic cables, wires, cords, chains, tethers, or the like. In another embodiment, cart 142 can be a tethered cart and may be coupled to its drive source using a chain, belt, rope, and/or any other suitable fastening device.

Cart 142 can be of any suitable size and, in one embodiment, can have a length substantially similar to the length of wood treatment vessel 120 such that at least about 50 percent, at least about 75 percent, at least about 90 percent, or substantially all of cart 142 can enter vessel 120 when introducing bundle of wood 104 into the interior of wood treatment vessel 120. In one embodiment, cart 142 can have an overall length, designated as L_{c} in FIG. 1, longer than the maximum internal dimension of wood treatment vessel 120, designated as Lᵥ in FIG. 1. The ratio of the overall length of cart 142 to the maximum internal dimension of wood treatment vessel 120 can be at least about 1.01:1, at least about 1.1:1, at least about 1.25:1, at least about 1.3:1 or at least about 1.5:1 and/or no more than about 15:1, no more than about 10:1, or no more than about 8:1. The overall length of cart 142 can be at least about 4 feet, at least about 8 feet, at least about 12 feet, at least about 16 feet and/or no more than about 100 feet, no more than about 50 feet, no more than about 35 feet, or no more than about 25 feet, while the width can be slightly more than, slightly less than, or approximately the same as the width of bundle support structure 146. In one embodiment, the width of cart 142 is substantially less than the width of bundle support structure, such that the ratio of the width of bundle support structure 146 to the width of cart 142 is at least about 1.25:1, at least about 1.5:1, at least about 1.75:1 and/or not more than about 3:1, not more than about 2.5:1, or not more than about 2:1.

Bundle transport system 140 can employ a include suitable cart drive system for enabling the movement of cart 142 within wood treatment facility 100. In one embodiment, the cart drive system of wood treatment facility can include at least one active drive component and at least one passive drive component. As used herein, the term “active” refers to an object or component of a system that acts upon other objects or components of within the system to thereby cause motion. An active component can be an energy provider and, in particular, a provider of kinetic energy to drive, for example, a passive component. As used herein, the term “passive” refers to an object or component of a system that is acted upon by other objects or components within the system and, consequently, can be put into motion. A passive component can be an energy receiver and, in particular, a receiver of kinetic energy provided by one or more active components within the system.

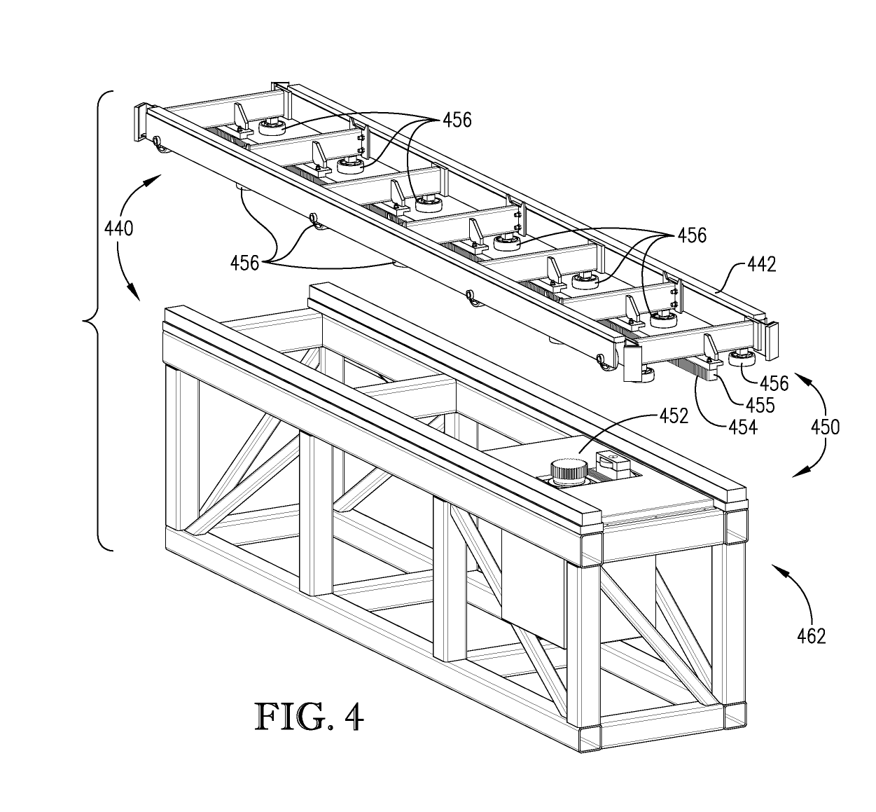

Turning now to FIG. 1, one embodiment of a bundle transport system 440 comprises a suitable cart drive system 450 is shown. Bundle transport system includes a cart 442, which can include a plurality of wheels 456 configured to contact rail segment 462 to thereby allow cart 442 to move within the wood treatment facility, as will be discussed in detail shortly. Cart drive system 450 illustrated in FIG. 4 comprises at least one active drive component (e.g., active component) 452, at least one passive drive component (e.g., passive component) 454. In one embodiment, active component 452 can be a stationary active component, physically separate from cart 442, while passive component 454 can be physically coupled to cart 442 and configured to move therewith. As used herein, the term “stationary” refers to an object or item that does not move in a direction substantially parallel to the axis of elongation of the vessel and/or the direction of motion of the cart, and the term “physically coupled” means affixed, attached, or otherwise fastened such that the two physically coupled objects or items have some degree of permanent or semi-permanent attachment and are not simply in contact with one another. This configuration is in contrast to most conventional cart systems, which typically employ at least one active component (e.g., a motor) coupled to or otherwise physically associated with the cart itself.

Active and passive components 452, 454 of cart drive system 450 can be any suitable types of active or passive drive components operable to work together to move cart 442. In one embodiment, cart drive system 450 can comprise a rack and pinion drive system, wherein at least one of active and passive components 452, 454 comprises a rack and the other of active and passive components 452, 454 comprises a pinion. In one embodiment depicted in FIG. 4, cart drive system 450 comprises a passive rack 454 coupled to cart 442 and an active pinion 452 physically or permanently coupled to transport segment 462. Depending on its specific location within bundle transport system 440, when active component 452 is physically coupled to transport segment 462, active component 452 can be permanently fixed outside the interior of one or more wood treatment vessels (not shown in FIG. 4) during the duration of any chemical, thermal, or heating treatments carried out therein.

According to one embodiment of the present invention, the wood treatment systems described herein can also employ one or more movable transport segments, operable to be shifted between a first position and a second position to thereby accommodate the transport and/or treatment of a bundle of wood. In one embodiment, the bundle transport system can include one or more movable transport segments (e.g., door shuttles) shiftable to accommodate the opening and/or closing of at least one of the doors of a wood treatment vessel. In another embodiment, the wood treatment systems described herein may also include one or more shiftable transport segments which do not move in a direction parallel to the axes of elongation of the wood treatment vessel or vessels, but can be shifted between vessels in a direction substantially perpendicular to the axes of elongation of one or more vessels in the facility. When the wood treatment vessel includes two oppositely disposed doors or the wood treatment facility includes more than one treatment vessel, the bundle transport system can include as many movable transport segments as needed to optimize operation of the facility. Several embodiments of wood treatment facilities including movable and/or shiftable transport segments are discussed in further detail below.

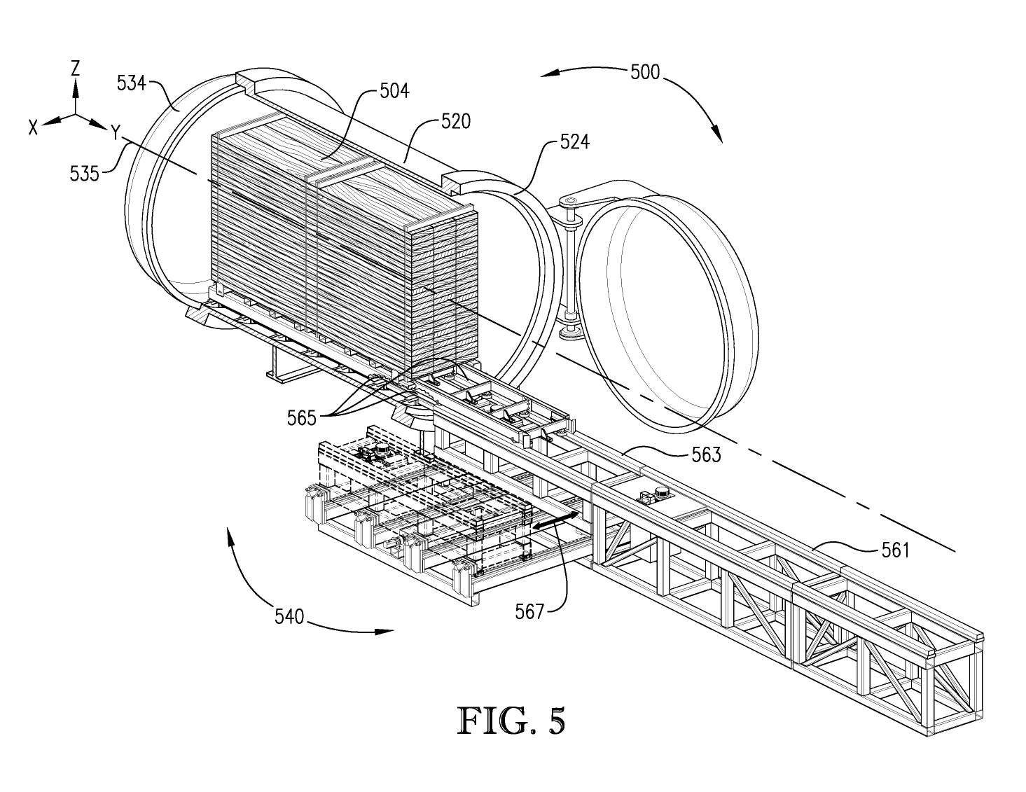

Turning now to FIG. 5, one embodiment of a wood treatment facility 500 employing a bundle transport system 540 having a movable transport segment 563 is illustrated. As shown in FIG. 5, movable transport segment 563 can be disposed between a fixed transport segment 561, located proximate entrance door 524 of wood treatment vessel 520, and an internal transport segment 565, disposed within the interior of wood treatment vessel 520. In one embodiment, movable transport segment 563 can be shorter than fixed and/or internal transport segments 561, 565, and can also be shorter than the overall length of wood treatment vessel 520. For example, according to one embodiment, the ratio of the overall length of movable transport segment 563 to the maximum internal dimension of wood treatment vessel 520 can be less than about 0.90:1, less than about 0.85:1, less than about 0.75:1, less than about 0.60:1, less than about 0.45:1, or less than about 0.3:1. In one embodiment, the length of movable transport segment 563 can be at least about 2 feet, at least about 4 feet, or at least about 6 feet and/or no more than about 25 feet, no more than about 20 feet, no more than about 16 feet, or no more than about 12 feet. Movable transport segment can be moved according to any suitable mechanism and, in one embodiment, at least a portion of its movement can be regulated, coordinated, or controlled by an automatic control system (not shown in FIG. 5).

According to one embodiment, movable transport segment 563 can be shiftable between an engaged (e.g., aligned) position (or configuration) wherein fixed and internal transport segments 561, 565 are aligned, as shown in FIG. 5, and a disengaged (e.g., retracted) position (or configuration) wherein fixed and internal transport segments 561, 565 are not aligned, as shown by dashed lines 564 in FIG. 5. As used herein, the term “aligned” means arranged in a substantially straight line. In one embodiment, movable transport segment 563 can be shifted between an engaged and a disengaged position in a lateral direction substantially perpendicular to the axis of elongation 535 of vessel 530, as indicated by arrow 567 in FIG. 5. At least a portion of the shifting between the engaged and disengaged position can also be carried out in a single plane substantially parallel to the horizontal (e.g., xy-plane), such that substantially no vertical motion occurs during shifting.

In operation, a bundle of wood 504 can be loaded onto a cart 542 (and, optionally, a bundle support structure 546) while the entrance door 524 of wood treatment vessel 520 is closed and movable transport segment 563 is in a retracted position wherein internal transport segment 565 and fixed transport segment 561 are not aligned, as described above. To load wood treatment vessel 520, first entrance door 524 can be opened and, subsequently, movable transport segment 563 can be laterally shifted from its retracted position to an aligned position, wherein internal transport segment 565 and fixed transport segment 561 are aligned to thereby allow bundle 504, optional bundle support structure 546, and cart 542 to pass over at least a portion of movable transport segment 563 and into the interior of treatment vessel 520. In one embodiment, at least a portion or substantially all of the weight of bundle 504 and cart 542 can be supported by movable transport segment 563 as bundle 504 is loaded into wood treatment vessel 520.

After bundle 504 has been loaded into the interior of wood treatment vessel 520, movable transport segment 563 can be shifted back into a retracted (e.g., disengaged) position, and entrance door 524 can be closed and sealed prior to initiating treatment in vessel 520. Once the treatment of bundle 504 has been completed, the basic operation described herein with respect to movable transport segment 563 can subsequently be repeated when removing a treated bundle 504 from vessel 520. Similarly, when wood treatment facility 500 includes two or more wood treatment vessels, a similar procedure can be followed with one or more other movable transport segments when loading and/or unloading a treated or untreated bundle into and/or out of one or more other treatment vessels, such as, for example another chemical modification reactor or a heater (not shown in FIG. 5). Several embodiments of wood treatment facilities employing multiple wood treatment vessels will be discussed in detail shortly.

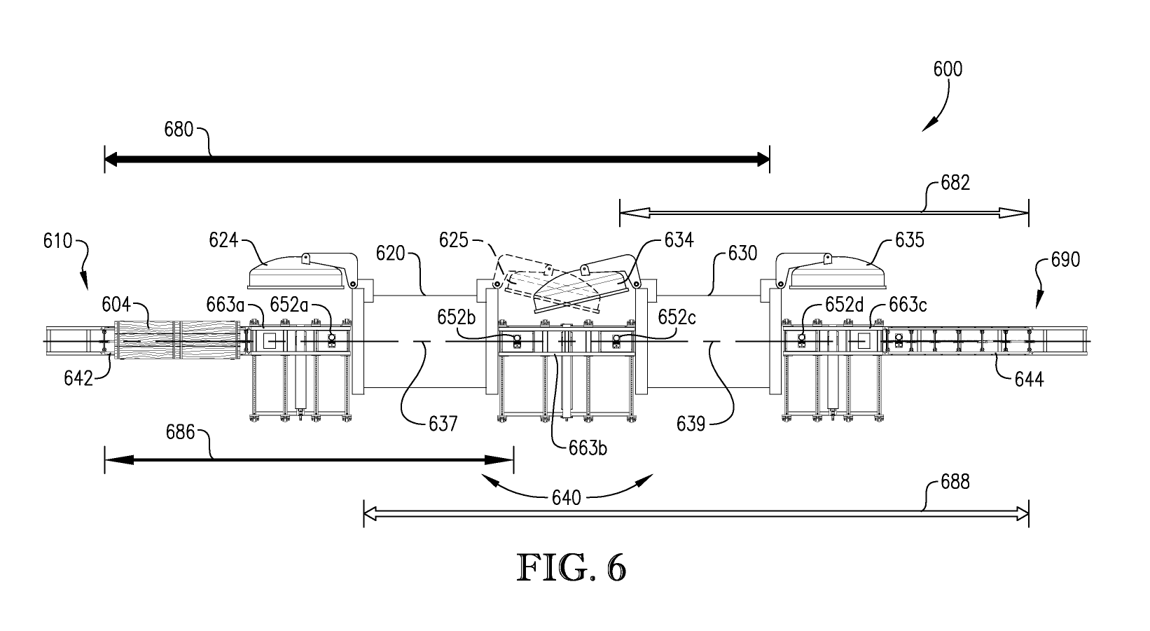

Turning now to FIG. 6, one embodiment of a wood treatment system 600 is illustrated as comprising a first wood treatment vessel 620, a second wood treatment vessel 630, and a bundle transport system 640 for moving one or more bundles of wood into and/or out of vessels 620 and 630 and amongst various locations within wood treatment facility 600. In the embodiment shown in FIG. 6, first and second wood treatment vessels 620, 630 each comprise an entrance door 624, 634 and an exit door 625, 635 positioned on a generally opposite end of vessel 620, 630 from entrance door 624, 634. According to one embodiment wherein each of vessels 620 and 630 comprise separate entrance and exit doors, the axes of elongation of each vessel, shown as axes 637, 639 respectively, can be substantially parallel or substantially aligned, as illustrated in FIG. 6. When first and second wood treatment vessels 620, 630 are substantially aligned, exit door 625 of first wood treatment vessel 620 can be spaced from entrance door 634 of second wood treatment vessel 630 by no more than about 2,000 feet, no more than about 1,000 feet, or no more than about 750 feet, measured along the shortest straight line between exit door 625 and entrance door 634. In the embodiment wherein a transport path extends between exit door 625 and entrance door 634, the transport path can have the dimensions as described above.

Each of wood treatment vessels 620, 630 can be utilized for one or more of the types of treatment as described in detail previously. For example, in one embodiment, first wood treatment vessel 620 can be a chemical modification reactor, while second wood treatment vessel 630 can be a wood heater. In another embodiment, first wood treatment vessel 620 can be an acetylation reactor and second wood treatment vessel 630 can be a microwave heater or dryer. Although shown in FIG. 6 as comprising two vessels, it should be understood that wood treatment facilities configured according to various embodiments of the present invention can employ any suitable number of vessels in any suitable configuration. For example, a wood treatment facility configured according to one embodiment can include at least about two, at least about three, or at least about four wood treatment vessels, with two or more vessels operated in parallel and/or series. For example, in one embodiment, a single wood modification vessel (e.g., reactor) can be followed by a plurality of wood dryers or heaters operated in parallel, while, in another embodiment, a plurality of wood modification vessels can be followed by a single heater or dryer. Specific configurations can be dependent, in part, on a variety of process-specific and/or site-specific factors.

Turning back to the embodiment of wood treatment facility 600 shown in FIG. 6, bundle transport system 640 can comprise at least about two carts operable to move along one or more defined, or dedicated, transport paths within wood treatment facility 600. As used herein, the term “defined transport path” refers to a path or direction of travel followed by one or more carts within the treatment facility. For example, in one embodiment, a first and a second cart 642, 644 can be configured to travel along defined transport paths 680 and 682, respectively, while, in another embodiment, first and second carts 642, 644 can be configured to respectively travel along defined paths 686 and 688, shown in FIG. 6.

According to one embodiment, a first (or reactor) cart 642 can be operable to load first vessel 620 through entrance door 624 and/or a second (or heater) cart 644 can be operable to unload second vessel 630 via exit door 635. At least one of carts 642 and 644 can be operable to unload the bundle of wood, after treatment, from first wood treatment vessel 620 via exit door 625 and/or load the bundle of wood removed from first wood treatment vessel 620 into second wood treatment vessel 630 via entrance door 634. In one embodiment, at least one of carts 642, 644 passes through the interior of first and/or second wood treatment vessels 620, 630 in order to move the treated bundle between exit door 625 of treatment vessel 620 and entrance door 634 of treatment vessel 630. For example, in one embodiment wherein cart 442 is used to unload first wood treatment vessel 620, reactor cart 642 can pass entirely through the interior of treatment vessel 620 to transport the treated bundle to vessel 630, along a path indicated by arrow 680 in FIG. 6. In another embodiment wherein heater cart 644 is used to unload first wood treatment vessel 620, cart 644 can pass entirely through the interior of treatment vessel 630 prior to unloading the treated bundle from vessel 620, as depicted by arrow 688 in FIG. 6. According to one embodiment, the other of carts 642, 644 can be used to respectively load first wood treatment vessel 620, as indicated by arrow 686, or unload second wood treatment vessel 630, as shown by arrow 682 in FIG. 6.

The operation of wood treatment facility 600 will now be described in detail with respect to FIG. 6. Although described with respect to the treatment of a single bundle passing through the system, it should be understood that multiple bundles may be processed by wood treatment facility 600 at substantially the same time, such that first and/or second wood treatment vessels can be simultaneously treating two or more bundles, while one or more other treated or untreated bundles can be unloaded or loaded in zones 690, 610, respectively.

Turning first to loading zone 610, in one embodiment of the present invention, a bundle of wood 604, as described previously, can be loaded onto a bundle support structure (not shown in FIG. 6) supported on first reactor cart 642. In one embodiment, at least a portion of the loading can be carried out using a lift system (not shown in FIG. 6) similar to the internal lift systems described previously, but located outside vessels 620 and 630 in loading area 610. Entrance door 624 of first wood treatment vessel (e.g., chemical modification reactor 620) can then be opened, which, in one embodiment, can include shifting movable segment 663a to a retracted position as described above. Once movable segment 663a has been returned to an aligned position, bundle 604 and bundle support structure, supported on cart 642, can then be loaded into the interior of chemical modification reactor 620.

Cart 642 can comprise an externally driven cart and can be moved using a cart drive system that includes a plurality of active pinions 652a-d and at least about two passive racks (not shown in FIG. 6) coupled to respective carts 642, 644. In one embodiment, the passive rack physically coupled to cart 642 can become engaged by active pinion 652a, which rotates thereby moving cart 642, along with bundle 604 and bundle support structure, along the rail segment and into first wood treatment vessel 620. According to one embodiment wherein exit door 625 has also been opened prior to loading vessel 620, the leading edge of the passive rack on cart 642 engages a second active pinion 652b, located proximate exit door 625 and physically coupled to movable segment 663b at approximately or nearly the same time that first active pinion 652a disengages the lagging (e.g., back) edge of the passive rack, thereby pulling cart 642 into the interior of vessel 620 such that at least about 50 percent, at least about 75 percent, at least about 90 percent, or substantially all of cart 642 is located within the interior of first wood treatment vessel 620. Utilizing a second active pinion 652b to pull cart 642 into the interior of first wood treatment vessel 620 may be particularly useful when, for example, the length of cart 642 is greater than the maximum internal length of vessel 620.

Once inside the interior of wood treatment vessel 620, an internal lift system (not shown in FIG. 6, but described previously with respect to FIGS. 3a and 3b) can remove bundle 604 and the bundle support structure from cart 642, which can then be withdrawn from chemical modification reactor 620 in a similar, but reverse, manner, utilizing active pinion 652a (and, optionally, active pinion 652b) and the passive rack coupled to cart 642. Once cart 642 has been completely removed from the interior of wood treatment vessel 620, movable transport segment 663a (and 663b, if applicable) can be shifted to a retracted position and entrance door 624 (and exit door 625, if applicable) can be closed and sealed. Treatment (e.g., chemical modification or acetylation) can then be initiated with movable segment(s) 663a and, optionally 663b, remaining in either retracted or aligned positions for the duration of the treatment.

After bundle 604 has undergone treatment in first wood treatment vessel 620, entrance door 634 of second wood treatment vessel (e.g., wood heater) 630 and exit door 625 of chemical modification reactor 620 can be opened in series, after shifting movable transport segment 663b from an aligned position to a retracted position. In one embodiment of the present invention, wood treatment facility 600 can comprise a containment room (not shown in FIG. 6) for encompassing the space surrounding exit door 625 and entrance door 634 and at least partially containing one or more components (e.g., chemical components or reagents) whose emissions may require enhanced monitoring or control (e.g., acids, VOCs, etc.).

Next, entrance door 624 can be opened after shifting movable transport segment 663a into a retracted position and, after realigning movable segment 663 into an engaged position, empty reactor cart 642 can be reintroduced into the interior of first wood treatment vessel 620. Thereafter, the internal lift system (not shown) can be used to load the treated bundle of wood 604 and the bundle support structure back onto reactor cart 642. According to one embodiment, the active drive component (e.g., active pinion 652b) located proximate first reactor exit door 625 can then engage the passive rack coupled to cart 642, and rotate to pull treated bundle 604 and the bundle support structure out of the interior of first wood treatment vessel 620 via cart 642. In cooperation with another active drive component 652c coupled to movable segment 663b, reactor cart 642 can be moved into the interior of second wood treatment vessel 630 via entrance door 634. Another lift system (not shown), located within the interior of wood treatment vessel 630, can then be used to load the treated bundle 604 and bundle support structure off of cart 642 into the interior of second wood treatment vessel 630 for further treatment.

Once bundle 604 and the bundle support structure are removed from reactor cart 642, active drive components 652a-c can cooperatively remove cart 642 from the interior of second wood treatment vessel via entrance door 634 and return cart 642 to loading zone 610 via passage through exit door 625, the interior of first wood treatment vessel 620, and entrance door 624. In loading zone 610, another bundle (not shown) can then be loaded onto reactor cart 642 and introduced into first wood treatment vessel 620, as previously described. Each of doors 625, 624, and 634 can be sequentially shut, after appropriate movements of movable segments 663a,b have been retracted and treatment can be initiated in both first and second wood treatment vessels 620, 630 at approximately the same time.

Upon the completion of treatment in second wood treatment vessel 630, movable transport segment 663c can be retracted and exit door 635 can be opened. After repositioning movable transport segment 653c into an aligned position, active drive component 652d, which can be physically coupled to movable transport segment 653c, can engage the passive rack physically coupled to second heater cart 644, thereby moving cart 644 into the interior of second wood treatment vessel 630. Once inside the vessel, the lift system (not shown) can be used to lower the further treated (e.g., heated) bundle of wood and the bundle support structure down onto the empty cart 644. Active component 652d can then reengage the passive component coupled to cart 644 and, operating in an opposite direction, can withdraw cart 644, the bundle support structure, and treated bundle 604 from the interior of second wood treatment vessel and into an unloading zone 690, as shown in FIG. 6. In one embodiment, another lift system can be used to remove bundle 604 and the bundle support structure from cart 644 in unloading zone 690. Bundle 604 can be transported to another location (not shown) for subsequent storage or processing (e.g., milling), while the bundle support structure can be returned to loading zone 610 for use with another bundle of wood, which can then be processed in a similar manner as previously described.

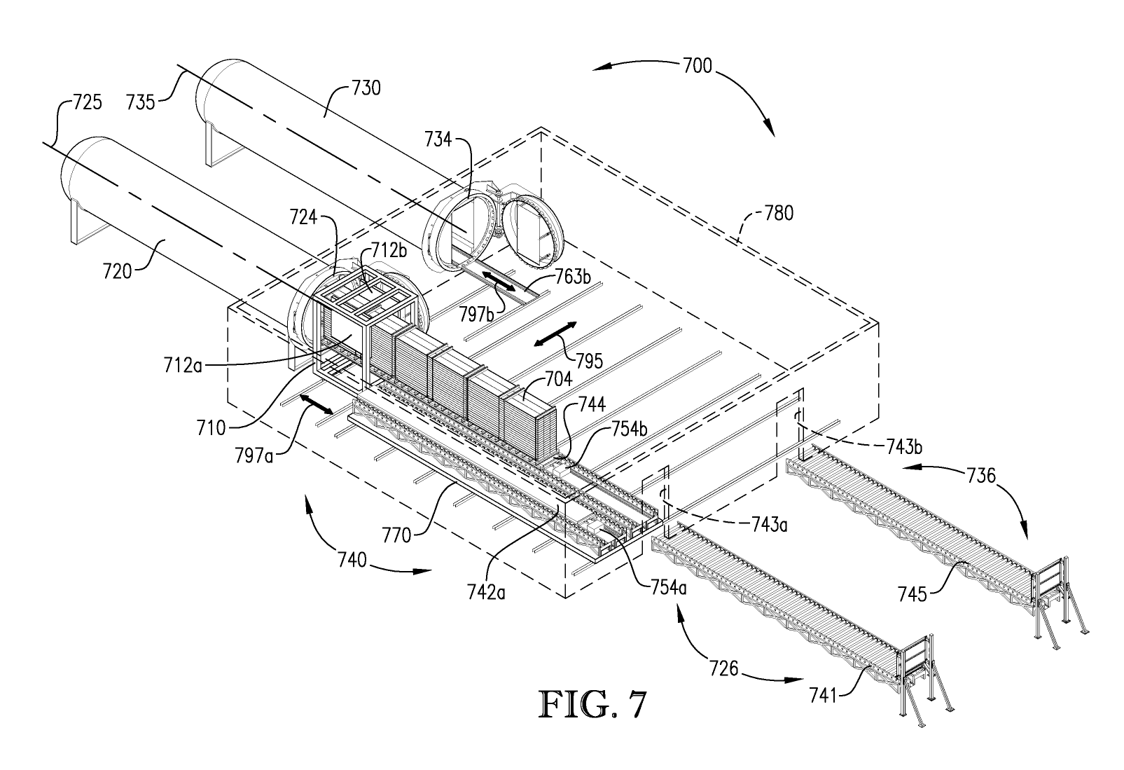

Referring now to FIGS. 7-11, various aspects of another embodiment of a wood treatment facility 700 are illustrated. As shown in FIG. 7, wood treatment facility 700 comprises a first wood treatment vessel 720, a second wood treatment vessel 730, and a bundle transport system 740 for moving one or more bundles of wood, represented by bundle 704, into, out of, and/or between first wood treatment vessel 720 and second wood treatment vessel 730. First and second wood treatment vessels 720, 730 can comprise any suitable type of wood treatment vessels discussed previously, including, for example, a chemical modification vessel (or chemical treatment vessel or chemical modification reactor) and a wood heater or dryer. In another embodiment, first wood treatment vessel 720 can comprise an acetylation reactor and/or second wood treatment vessel 730 can comprise a microwave wood heater.

First and second wood treatment vessels 720, 730 can be arranged such that the central axes of elongation 725 and 735 of treatment vessels 720, 730 are substantially parallel to one another. Specifically, in one embodiment, first and second wood treatment vessels 720, 730 can be oriented in a side-by-side configuration, as generally shown in FIG. 7. Each of wood treatment vessels 720 and 730 can include a respective entrance door 724, 734 for allowing a bundle of wood 704 to be introduced into the interior of reactor 720 or heater 730. In one embodiment, one or both of entrance doors 724 and 734 may be the only door for respective wood treatment vessels 720 and 730, such that bundle 704 is both introduced into and removed from first wood treatment vessel (e.g., chemical modification reactor) 720 through first door (e.g., reactor door) 724 and bundle 704 is introduced and removed from second wood treatment vessel (e.g., wood heater) 730 through second door (e.g., heater door) 734. Additional details regarding loading and unloading of bundle 704 from chemical modification reactor 720 and wood heater 730 will be discussed in detail shortly.

Bundle transport system 740 shown in FIG. 7 is configured to move bundle 704 into, out of, and between chemical modification reactor 720 and wood heater 730 and an optional containment room 780 for enclosing at least a portion of bundle transport system 740. Containment room 780, when present, may be operable to isolate or substantially minimize fluid flow communication between the enclosed portion of bundle transport system 740 (e.g., the interior volume of containment room 780) and an external environment. In one embodiment, doors 724, 734 of chemical modification reactor 720 and wood heater 730 may open into containment room 780, which can prevent emission of one or more vaporizable chemicals or other materials from reactor 720 and/or heater 730 into the surrounding environment. Further, as the chemically-modified bundle of wood 704 is transported from reactor 720 to heater 730, one or more volatile components may vaporize from the chemical-wet bundle and into the surrounding environment. Containment room 780 may be used when, for example, one of more volatile components used in wood treatment facility 700 are undesirable for personnel exposure or environmental release and/or if such a material poses a fire or explosion risk.

Containment room 780 may be configured in any suitable way to prevent leakage of one or more undesirable chemical components to the environment. In one embodiment, containment room 780 may be coupled to one or more ventilation and chemical disposal devices (not shown) and may draw air (or other inert gas) in through one or more vents or slats in order to cyclically purge the vapor volume of the enclosed space. Containment room 780 may be operable to remove undesirable vapors from its interior and/or from the interior of chemical modification reactor 720 and/or wood heater 730. One embodiment of a containment room suitable for use in a wood treatment facility as described herein is described in co-pending U.S. application Ser. No. 13/323,184, the entirety of which is incorporated herein by reference to the extent not inconsistent with the present disclosure.

As shown in FIG. 7, bundle transport system 740 is illustrated as comprising a first cart 742 and a second cart 744 for transporting one or more bundles of wood 704 into and/or out of chemical modification reactor 720 and wood heater 740. Although described herein as comprising two carts, it should be understood that various embodiments of wood treatment facility 700 may include a single cart or more than two carts. Each of carts 742 and 744 are configured to at least partially support bundle 704 as it is transported into, out of, and/or between first reactor door 724 of chemical modification reactor 720 and second heater door 734 of wood heater 730.

According to one embodiment, each of first and second carts 742, 744 are movably coupled to a bundle transport shuttle 770 for transporting first and second carts 742, 744 back and forth between chemical modification reactor 720 and wood heater 730, as generally indicated by arrow 795 in FIG. 7. As each of carts 742 and 744 are configured to move relative to bundle transport shuttle 770 when loading and/or unloading bundle 704 from chemical modification reactor 720 and/or wood heater 730, bundle transport shuttle may be configured to travel in a direction generally perpendicular to the direction of travel of first and/or second cart 742, 744, which are generally represented by arrows 797a,b in FIG. 7. When the axes of elongation 725, 735 of chemical modification reactor and wood heater 720, 730 are substantially parallel to each other, bundle transport shuttle 770 can be configured to travel in a direction substantially perpendicular to the axes of elongation of one or both of chemical modification reactor 720 and wood heater 730. Operation of wood treatment facility 700, including the positioning of bundle shuttle 770 and each of first and second carts 742, 744 according to various embodiments of the present invention, will be discussed in detail shortly.

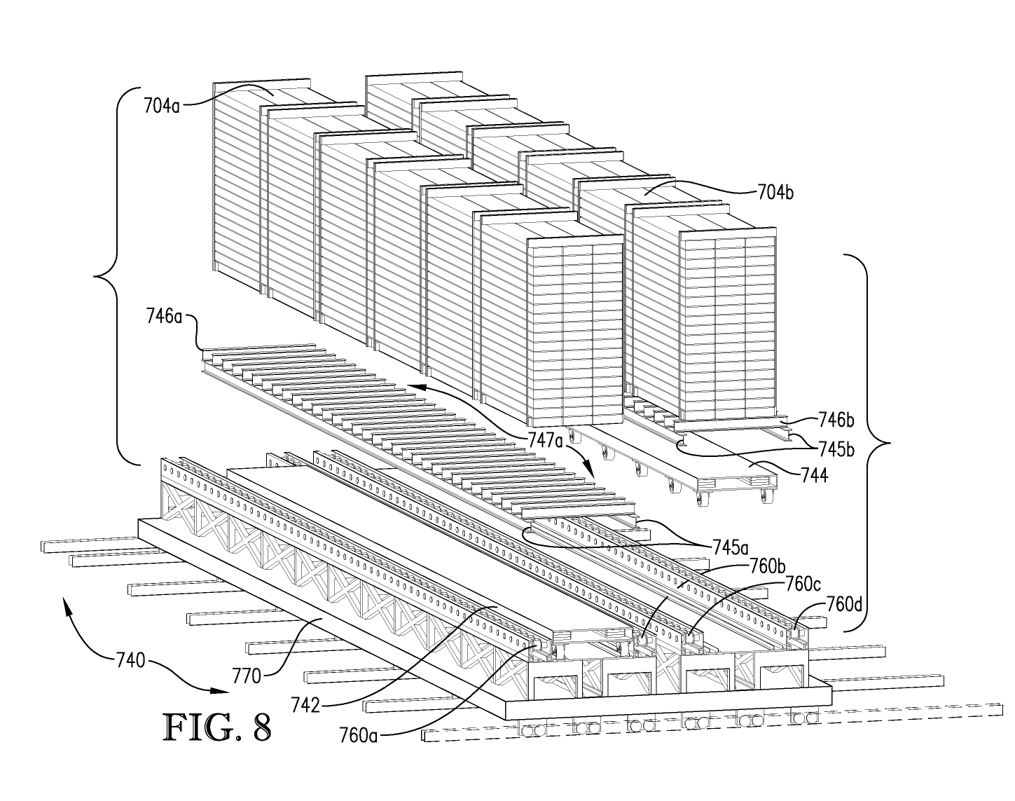

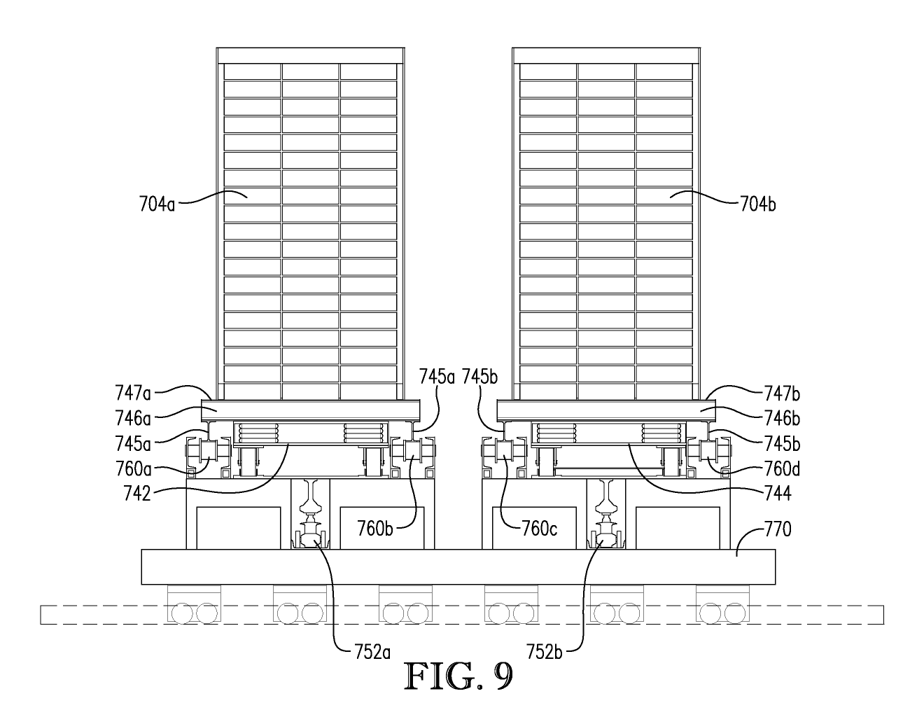

Turning now to FIGS. 8 and 9, additional details of bundle transport shuttle 770 suitable for use in wood treatment facility 700 are provided. As shown in FIGS. 8 and 9, first and second carts 742, 744 of bundle transport system 740 are coupled to bundle transport shuttle 770 in a generally side-by-side configuration. Each of carts 742 and 744 can be configured to carry at least one bundle of wood 704a,b, and at least one bundle support device 746a,b, as described in detail previously. Bundle support devices 746a,b can be removably coupled to first and/or second carts 742 and 744, such that bundle support devices 746a,b remain with corresponding bundles of wood 704a,b throughout the entire treatment process.

Bundle support devices 746a,b can be configured according to one or more embodiments described in detail previously. In another embodiment, as generally depicted in FIGS. 8 and 9, each bundle support structure 746a,b can comprise a pair of support arms 745a,b individually coupled to and extending downwardly and/or outwardly from a bundle support surface 747a of bundle support structure 746a (surface of bundle support structure 746b not shown). Support arms 745a,b can be configured to at least partially support the weight of bundle 704a,b before, during, and/or after transportation into and/or out of reactor 720 and/or heater 730. According to one embodiment illustrated in FIGS. 8 and 9, support arm pairs 745a,b can be configured to contact one or more stationary support structures, illustrated as pairs of split roller conveyors 760a and 760b and 760c and 760d, when bundles 704a,b and bundle support structures 746a,b are supported on and being transported by respective carts 742, 744. In one embodiment, stationary support structures 760a-d can be physically separate from carts 742 and 744 such that carts 742 and 744 can move relative to support structures 760 when moving into and/or out of a wood treatment vessel (not shown). Such a configuration may be utilized when, for example, the maximum width of bundle 704a,b and/or bundle support structure 746a,b exceeds the maximum width of cart 742 or 744 to impart additional stability to bundle 704a,b and/or bundle support structure 746a,b during transport.

Bundle transport system 740 of wood treatment facility 700 further comprises a cart drive system 750 comprising at least one active component 752a,b for providing energy to move at least one of first and second carts 742, 744 and at least one passive component 754a,b for receiving at least a portion of the energy produced by active component or components 752a,b and moving at least one of carts 742 and 744. Active and/or passive components 752a,b and/or 754a,b of cart drive system 750 can comprise one or more features of cart drive systems described previously. In one embodiment, for example, one or more active components 752a,b can be physically separate from carts 742 and 744 and/or one or more passive components can be physically coupled to and configured to move with carts 742 and/or 744. In one embodiment, one or more active components 752a,b can be stationary components and may not move in a direction generally parallel to the axes of elongation of reactor 720 and/or wood heater 730. In another embodiment, however, one or more passive components 754a,b can be configured to move with at least one of carts 742 and/or 744 along a path substantially parallel to the path of travel of each cart.

Referring specifically to FIGS. 7 and 9, one embodiment of a cart drive system 750 is illustrated as generally comprising a first and second active component, particularly illustrated as chain drive motors 752a,b in FIG. 9, and first and second passive components, particularly illustrated as pusher carts 754a,b in FIG. 7. As shown in FIG. 9, active component 752a,b are positioned at a lower vertical elevation than each of carts 742, 744 and, accordingly, are physically separate from the carts. Active components 752a,b can be coupled to bundle transport shuttle 770 and may, in one embodiment, be configured to move in a direction perpendicular to the axes of elongation of the wood treatment vessels into which bundles 704,b are transported. Active components 752a,b may be permanently located outside the interiors of wood treatment vessels 720, 730 of wood treatment facility 700, and may, or may not, be stationary components that do not move as carts 742, 744 transport bundles 704a,b into and/or out of the vessels. Pusher carts 754a,b can be configured to move in a back-and-forth (in-and-out) direction along a direction parallel to the axes of elongation 725, 735 of wood treatment vessels 720, 730 in order to introduce and/or remove carts 742, 744 and/or bundles 704a,b into and/or out of wood treatment vessels 720 and 730. Additional details regarding the operation of wood treatment facility 700 will be discussed shortly

Similarly to previously-described embodiments of the present invention, wood treatment facility 700 can also comprise at least one lift system for vertically disengaging bundle 704 and a bundle support structure supporting bundle 746 within the interior of at least one of chemical modification reactor 720 and wood heater 730. The lift system utilized by wood treatment facility 700 can be similar to the one described previously with respect to FIGS. 3a and 3b and may be physically coupled to at least a portion of chemical modification reactor 720 and/or wood heater 730. In another embodiment, particularly depicted in FIGS. 10a and 10b, wood treatment system 700 can utilize a lift system 1070 which is not coupled to either of chemical modification reactor 720 or wood heater 730. In one embodiment, lift system 1070 may be coupled to at least one of first and second carts 742, 744 and may be removed from the interior of reactor 720 and/or heater 730 prior to treatment of bundle 704.

Referring now to FIGS. 10a and 10b, a lift system 770 configured according to one or more embodiments of the present invention is provided. As shown in FIGS. 10a and 10b, lift system 770 is physically coupled to and configured to move with cart 742. Similarly to embodiments of the lift system described previously, lift system 770 is shiftable from an extended position, wherein at least a portion of lift system 770 is extended upwardly in a direction toward the axis of elongation 735 (or plane parallel thereto) of wood treatment vessel 720, and a retracted position wherein at least a portion of lift system 770 is retracted downwardly in a direction away from the axis of elongation 735 (or plane parallel thereto) of wood treatment vessel 720. Further, like previously-described embodiments, lift system 770 can be shiftable between a retracted position and an extended position within the interior of wood treatment vessel 720 to thereby vertically disengage bundle 704 and/or bundle support structure 746 from cart 742. Although shown in FIGS. 10a and 10b as being coupled to a first cart 742, it should be understood that, when multiple carts are utilized within a wood treatment facility, the facility can employ any suitable number of lift systems including, for example, one lift system coupled to each cart.

Lift system 770 can include one or more components capable of contacting and lifting bundle 704 and/or bundle support structure 742 in a substantially vertical direction to thereby vertically decouple or disengage bundle 704 and bundle support structure 746 from cart 742. In one embodiment, lift system 770 can include a plurality of extensible support arms, as described in detail previously, or, in another embodiment, it can include one or more pneumatically-driven lift surfaces (shown as air bag lifts 772a, b) operable to change the vertical position of bundle 704 and/or bundle support device 746 within the interior of wood treatment vessel 720. When multiple pneumatically-driven lift surfaces are utilized, the devices may be coupled to a common frame (not shown) to ensure synchronous movement. In one embodiment, lift system 770 can include at least 4, at least 6, at least 8 and/or not more than 24, not more than 18, or not more than 16 bundle lift devices spaced out along the length of cart 742.

According to one embodiment, as bundle 704 and bundle support structure 746 are transported by cart 742 into the interior of wood treatment vessel 720, lift system 770 may be configured to be in an extended position, such that bundle 704 and/or bundle support structure 746 are slightly elevated over the transport segment (not shown) along which cart 742 is being moved. Lift system 770 may be utilized, for example, when bundle support structure 746 includes a pair of support arms 745 and a stationary support structure (not shown in FIGS. 10a,b), as described previously with respect to FIGS. 8 and 9. When bundle 704, bundle support structure 746, and cart 742 enter wood treatment vessel 720, as shown in FIG. 10a, lift system 770 may shift from an extended position (as shown in FIG. 10a) to a retracted position (as shown in FIG. 10b), thereby placing at least a portion of bundle support structure 746 (e.g., support arms 745) in contact with a bundle support ledge 726 disposed in and couple to wood treatment vessel 720. As lift system 770 is shifted into a retracted position, as shown in FIG. 10b, cart 742 and lift system 770 can be removed from vessel 720 and treatment of bundle 704 may begin.

Upon completion of the treatment within wood treatment vessel 720, one of cart 742 and another cart (not shown) having a lift system 770 integrated therewith can be introduced into vessel 720 in a retracted position (as shown in FIG. 10b). Once inside the vessel, one or more of pneumatically-driven extensible support arms (e.g., air bag lifts 772a,b) can be extended in an upward direction to thereby contact a portion of bundle 704 and/or bundle support structure 746. Once contact is made, the extensible support arms 772a,b can continue to move upwardly toward the axis of elongation 735 of vessel 720, lifting bundle 704 and bundle support structure 746 off of the internal vessel supports. Thereafter, with lift system 770 in an extended position (as shown in FIG. 10a), bundle 704 and bundle support structure 746 can be removed from the interior of wood treatment vessel 720 via cart 742.

As shown in FIG. 7, wood treatment facility 700 can further comprise a bundle adjustment system 710 for ensuring bundle 704 maintains a desired size and/or shape before, during, and after its treatment in chemical modification reactor 720 and/or wood heater 730. In one embodiment, bundle adjustment system 710 can be operable to apply a force to at least a portion of one or more surfaces of bundle 704, thereby ensuring the size and/or shape of bundle 704 is maintained during treatment. As shown in one embodiment depicted in FIG. 7, bundle adjustment system 710 is located proximate first door 724 of chemical modification reactor 720 and can be configured to allow both bundle 704 and cart 742 to pass therethrough as the force is applied to bundle 704. In one embodiment, bundle adjustment system 710 may be permanently or semi-permanently affixed to its position proximate first door 724 of reactor 720, while, in another embodiment, bundle adjustment system 710 may be shiftable between an adjusting position proximate first door 724, as shown in FIG. 7, and a retracted position away from said first door 724 when, for example, first door 724 is closed. The force applied by bundle adjustment system 710 can be sufficient to realign one or more misaligned pieces of wood within bundle 704, but not enough to damage the wood. In one embodiment, the force applied by bundle adjustment system, 710 can be at least about 5 psi, at least about 10 psi, at least about 15 psi and/or not more than about 30 psi, not more than about 25 psi, or not more than about 20 psi.

The force applied by bundle adjustment system 710 can be applied continuously, while, in another embodiment, the force can be applied incrementally, in either time- or length-based intervals. In one embodiment, bundle adjustment system 710 can apply a force to bundle 704 at least about every least about every 2 feet, at least about every 4 feet, at least about every 6 feet and/or not more than about every 12 feet, not more than about every 10 feet, or not more than about every 8 feet as bundle 704 passes through bundle adjustment system 710 and into and/or out of reactor 720. As the process or processes carried out in chemical reactor 720 may substantially alter the size, shape, and/or alignment of bundle 704, it may be particularly desirable to utilize bundle adjustment system 710 during the unloading of the treated bundle 704 from chemical modification reactor 720. However, it is also contemplated that bundle adjustment system 710 may be used during the loading of reactor 720 and/or during the loading and/or unloading of heater 730, if desired.

Bundle adjustment system 710 can be an automated bundle adjustment system including one or more bundle adjusting devices, shown as contact surfaces 712a,b, and a control system (not shown in FIG. 7) for controlling the position of bundle adjusting devices 712a,b. In one embodiment, bundle adjustment system 710 may also include one or more position sensors (e.g., safety eyes) that alert operations personnel when a bundle is grossly misaligned. When present, the position sensors may also be in communication with the control system, which, in turn, may be responsive to adjust the position of one or more bundle adjusting devices 712a,b accordingly.

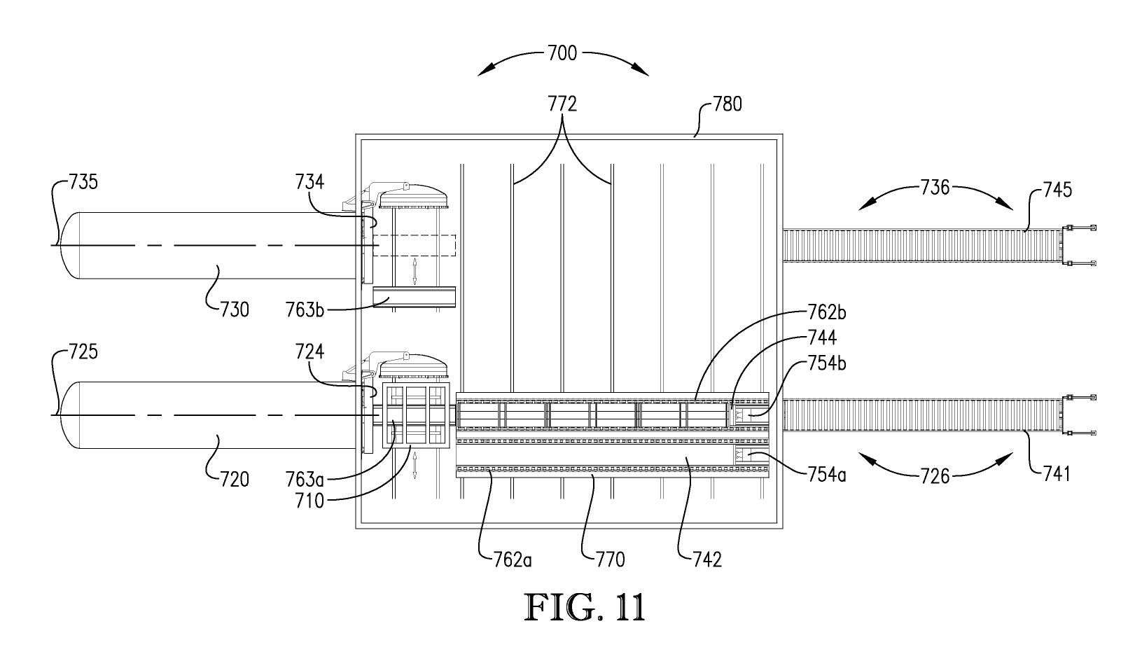

The operation of wood treatment facility 700 will now be described in detail below with particular reference to FIGS. 7 and 11. Initially, at least one bundle of wood 704 can be loaded onto a bundle support structure 746 disposed on a loading conveyor 741 of loading zone 726. As shown in FIGS. 7 and 11, wood treatment facility 700 may include a loading and an unloading zone 726, 736 located outside containment room 780. According to this embodiment, carts 742 and/or 744 may be configured to at least partially, or entirely, exit containment room 780 via respective loading 743a and unloading 743b doors to transport bundles of wood into and/or out of containment room 780. In one embodiment, doors 743a,b may include a closure device (not shown) so that the interior of containment room 780 may be substantially isolated from the external environment during treatment of bundle 704.

After bundle 704 has been loaded and centered on bundle support structure 746 in loading zone 726, one of carts 744 and 742 can pass through loading door 743a and into loading zone 726, wherein bundle 704 and bundle support structure 746 can be loaded onto an upper surface of the cart. At least a portion of the loading can be carried out using a lift system (not shown) configured to vertically reposition (e.g., lift and/or lower) bundle 704 and bundle support structure 746 onto cart 744 or cart 742. In one embodiment (not shown in FIGS. 7 and 11), the lift system may be physically coupled to loading conveyor 741 and may be operated in a manner similarly to lift system 370 described in detail previously with respect to FIGS. 3a and 3b. In an alternative embodiment, the lift system can be physically coupled to cart 744 or 742 and may be configured and operated similarly to lift system 1070, as described in detail previously with respect to FIGS. 10a and 10b.

Once loaded onto the cart, bundle 704 and bundle support structure 746 can then be transported through loading door 743a and into the interior of containment room 780, wherein cart 744 or 742 can transport bundle 704 and bundle support structure 746 along a respective transport segment 762b or 762a and into chemical modification reactor 720. Each of transport segments 762b,a can be a fixed transport segment coupled to bundle transport shuttle 770. Although transport segments 762b,a are configured to move with bundle transport shuttle 770 in a direction generally perpendicular to the axes of elongation 725, 735 of chemical modification reactor 720 and wood heater 730, transport segments 762b,a do not move in a direction parallel to the axes of elongation 725, 735 and do not move relative to carts 742, 744.

In order to introduce bundle 704 and bundle support structure 746 into the interior of chemical modification reactor 720, reactor movable transport shuttle 763a must be configured in an aligned or engaged position, as shown in FIG. 11, wherein movable transport shuttle 763a is aligned with one of fixed transport segments 762b,a of bundle transport shuttle 770 and an internal transport segment (not shown) disposed within the interior of chemical modification reactor 720. In one embodiment, movable transport segment 763a can support at least a portion of the weight of bundle 704 and cart 744 or 742 as the cart passes from fixed transport segment 762b or 762a and into reactor 720. Optionally, bundle adjustment system 710, which can be located proximate movable transport segment 762b or 762a and reactor door 724, can be used to adjust the position or alignment of at least a portion of bundle 704 as it passes through bundle adjustment system 710 and into reactor 720.

Once introduced into the interior of reactor 720, bundle 704 and bundle support structure 746 can be vertically disengaged from cart 744 or 742 via a lift system (not shown) in any manner described previously. Thereafter, cart 744 or 742 may be withdrawn from the interior of chemical modification reactor 720 using a respective cart pusher 754b or 754a, coupled to cart 744 or 742 and operable to move the cart in a generally back-and-forth direction into and out of chemical modification reactor 720 and/or wood heater 730. The motive energy for moving cart pushers 754b,a can be provided by respective active drive motors 752b,a physically separate from carts 744 and 742, but physically coupled to bundle transport shuttle 770. Drive motors 752b,a can be operable to move pushers 754b,a using one or more drive chains (not shown).

After cart 744 or 742 has been withdrawn from the interior of chemical modification reactor 720, movable transport shuttle 763a can be shifted from an aligned position, as shown in FIG. 11, to a retracted position, wherein movable transport segment 763a is not aligned with fixed transport segment 762b or 762a and the internal segment (not shown) within chemical modification reactor 720. Thereafter, first door 724 of reactor 720 may be closed and the treatment of bundle 704 within chemical modification reactor 720 may be initiated.

Once bundle 704 has been removed from loading zone 726, a second bundle of wood (not shown) may be assembled and loaded onto a second bundle support structure on loading conveyor 741. After bundle 704 is introduced into reactor 720 via one of carts 744 and 742, bundle adjustment shuttle 770 may be shifted slightly in a lateral direction, such that the other of carts 742 and 744 is aligned with loading door 743a. Cart 742 or 744 may then pass through loading door 743a of containment room 780 to retrieve the second bundle of untreated wood from loading zone 726. When the second bundle of wood has been loaded and centered onto the second bundle support structure in loading zone 726, cart 742 or 744 can then pass through loading door 743a and into containment room 780. Cart 742 or 744 can then pass onto fixed transport segment 762a or 762b of bundle transport shuttle 770.

Thereafter, bundle transport shuttle 770 may be shifted slightly in a lateral direction such that the other of empty carts 744 and 742 can be aligned with reactor door 724. Upon completion of the treatment of bundle 704 within reactor 720, reactor door 724 may be opened and movable transport segment 763a and bundle adjustment system 710 may be transitioned from a retracted position away from reactor door 724 to an aligned position as described previously. In one embodiment, the movement of movable transport segment 763a may be carried out at the same time as, or at a slightly different time as, the shifting of bundle transport shuttle 770 and/or bundle adjustment system 710. In one embodiment, bundle adjustment system 710 and movable transport segment 763a may be physically interlocked such that the movement of the movement of one is dependent on the movement of the other, while, in another embodiment, movable transport segment 763a and bundle adjustment system 710 may be independently shiftable with respect to each other.

Thereafter, empty cart 744 or 742 may be introduced into the interior of reactor 720, using cart pusher 754b or 754a driven by motor 752b or 752a. Treated bundle 704 and bundle support structure 746 can then be vertically repositioned and loaded onto cart 744 or 742 within the interior of chemical modification reactor 720. Once loaded, cart 744 or 742, treated bundle 704, and bundle support structure 746 may be withdrawn from chemical modification reactor 720 in a direction substantially parallel to the axis of elongation of reactor 720, over movable transport segment 763a and onto transport segment 762b or 762a of bundle transport shuttle 770.

After cart 744 or 742 is completely removed from the interior of reactor 720 and treated bundle 704 is positioned thereon, bundle transport shuttle 770 may then be shifted slightly in a lateral direction to thereby align the other of carts 742 and 744 with the entrance door 724 of reactor 720. In one embodiment, this may be carried out without shifting the position of movable transport segment 763a and/or bundle adjustment system 710. Once aligned, untreated second bundle of wood on cart 742 or 744 can then be transported into the interior of chemical modification reactor 720 in a similar manner as previously described with respect to bundle 704. The second bundle of wood may then be vertically disengaged from cart 742 or 744 via the same or a different lift system than was employed to vertically disengage bundle 704 from cart 744 or 742 before or after treatment. Empty cart 742 or 744 can then be fully removed from chemical modification reactor 720 before movable transport segment 763a and bundle adjustment system 710 are shifted back to a retracted position away from chemical modification reactor door 724. Thereafter, door 724 can be closed and treatment of the second bundle of wood can be initiated within reactor 720.

As treated bundle 704 and bundle support structure 746 remain at least partially supported on cart 744 or 742, bundle transport shuttle 770 can move along tracks 772 in a lateral direction generally perpendicular to axes of elongation 725, 735 of reactor 720 and heater 730 until loaded cart 744 or 742 is aligned with heater door 734. If heater door 734 is closed, it may be opened and a second movable transport segment 763b may be shifted from a retracted position, as shown in FIG. 11, to an aligned position, wherein movable segment 763b is aligned with fixed transport segments 762b or 762a and an internal transport segment (now shown) disposed within the interior of heater 730.

Once movable segment 763b is in an aligned position, cart 744 or 742 may be moved into heater 730 via cart pusher 754b or 754a driven by respective drive motor 752b,a. Once cart 744 or 742 is entirely or almost entirely within heater 730, treated bundle 704 and bundle support structure 746 may be vertically disengaged from cart 744 or 742 using the same or a different lift system than was used to vertically disengage bundle 704 within the interior of chemical modification reactor 720. Once treated bundle 704 has been unloaded into heater 730, empty cart 744 or 742 can be fully withdrawn from heater 730 and movable transport segment 743b can be shifted back into a retracted position so that door 734 can be closed. Thereafter, the heating and/or drying of treated bundle 704 can commence.

After loading treated bundle 704 into heater 730 and removing cart 744 or 742, bundle transport shuttle 770 can again be laterally shifted along tracks 772 so that the other cart 742 or 744, which is empty, is aligned with loading door 763a of containment room 780. A third untreated bundle (not shown) may then be loaded onto cart 742 or 744 in a similar manner as described previously. Thereafter, bundle transport shuttle 770 may shift slightly such that the other of carts 744 and 742, which is empty, is aligned with reactor door 724 of chemical modification reactor 720. After door 724 is opened, movable transport segment 763a and bundle adjustment system 710 can be cooperatively or separately shifted to aligned positions proximate reactor door 724. Thereafter, empty cart 744 or 742 can be introduced into the interior of chemical modification reactor 720, wherein the second treated bundle can be vertically positioned onto cart 744 or 742 using the same or different lift system than was previously employed. Once loaded, cart 744 or 742 can then remove the second treated bundle and bundle support structure from chemical modification reactor 720 and can position loaded cart 744 or 742 onto bundle transport shuttle 770.

Bundle transport shuttle 770 can then be slightly shifted in a lateral direction such that the other of carts 742 and 744, which is supporting a third, untreated bundle, is aligned with the open door 724 of reactor 720. Cart 742 or 744 can then load the untreated bundle into chemical modification reactor 720 as previously described and empty cart 742 or 744 can be withdrawn before door 724 is closed and treatment is initiated. Prior to closing door 724, bundle adjustment system 710 and movable transport segment 763a can be shifted from an aligned position to a retracted position away from door 724, as described previously.

Bundle transport shuttle 770 is then shifted laterally along tracks 772 so that the empty cart 742 or 744 is aligned with entrance door 734 of wood heater 730. Heater door 734 is opened and movable transport segment 763b can be shifted to an aligned position before empty cart 742 or 744 is introduced into the interior of wood heater 730. Once inside, the heated and/or dried bundle of treated wood can be vertically positioned onto cart 742 or 744 using the same or a different lift system than was used to unload treated bundle 704 into heater 730. The loaded cart 742 or 744 can then be fully removed from heater 730, passed along transport segment 762b, and through unloading door 743b and into unloading zone 736. Thereafter, treated and dried bundle 704 and bundle support structure may be removed from cart 742 or 744 onto unloading conveyor 745. Thereafter, the bundle, which may still have an elevated temperature, may be allowed to cool before being transported to another portion of wood treatment facility 700 for subsequent processing, storage, and/or use.

Empty cart 742 or 744 can then be passed back through unloading door 743b and onto transport segment 763b of bundle transport shuttle 770. Thereafter, bundle transport shuttle 770 may be shifted laterally such that the other of carts 744 and 742 is aligned with door 734 of heater 730. Cart 744 or 742, which is carrying the second treated bundle of wood, can then be introduced into wood heater 730 by passing over transport segments 762b and 763b before entering the interior of heater 730. Once inside, the second treated bundle can be vertically disengaged from cart 744 or 742 using the same or a different lift system as used previously and the empty cart 744 or 742 can be withdrawn using, for example, cart pusher 754b and active drive motor 752b. After returning movable transport segment 763b to a retracted position away from door 734 of heater 730, door 734 may be closed and the second treated bundle may be heated and/or dried.

Thereafter, bundle transport shuttle 770 and empty carts 742 and 744 are again shifted laterally along tracks 772 until cart 742 or 744 is aligned with loading door 743a. A fourth treated bundle (not shown) can then be loaded onto cart 742 or 744 in loading zone 726 as described previously and the above-described process be repeated as required in order to treat multiple bundles of wood within facility 700.

According to one embodiment of the present invention, the wood treatment facilities as described herein can comprise commercial-scale facilities for treating wood. In one embodiment, the wood treatment facilities of the present invention can have an annual production capacity of at least about 500,000 board feet, at least about 1 million board feet, at least about 2.5 million board feet, or at least about 5 million board feet. As used herein, the term “board feet” refers to a volume of wood expressed in units measuring 144 cubic inches. For example, a board having dimensions of 2 inches by 4 inches by 36 inches has a total volume of 288 cubic inches, or 2 board feet. In one embodiment, the internal volume of a single chemical modification reactor (e.g., the internal reactor volume) and/or the internal volume of a single heater (e.g., the internal heater volume) can be 100 cubic feet, at least about 500 cubic feet, at least about 1,000 cubic feet, at least about 2,500 cubic feet, or at least about 5,000 cubic feet in order to accommodate commercial-scale operation.

Even when carried out on a commercial scale, chemical and/or thermal modification processes as described herein can be carried out with relatively short overall cycle times. For example, according to one embodiment, the total cycle time of the chemical and/or thermal modification processes carried out using one or more systems of the present invention, measured from the time the modification step is initiated to the time the heating step is completed, can be no more than about 48 hours, no more than about 36 hours, no more than about 24 hours, or no more than about 12 hours, no more than about 10 hours, no more than about 8 hours, or no more than about 6 hours. This is in contrast to many conventional wood treatment processes, which can have overall cycle times that last several days or even weeks.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

We claim:

1. A system for treating wood, said system comprising:
a first wood treatment vessel for receiving at least one bundle of wood, wherein said first wood treatment vessel comprises a first door;
a bundle transport system comprising a first cart for transporting said bundle of wood into and/or out of said first wood treatment vessel through said first door; and
a lift system for vertically disengaging said bundle of wood from said first cart within the interior of said first wood treatment vessel.

2. The system of claim 1, wherein said first wood treatment is a chemical modification reactor and/or a wood heater.

3. The system of claim 1, wherein said lift system is disposed within the interior of said first wood treatment vessel during the vertical disengagement of said bundle from said first cart, but not during treatment of said bundle of wood.

4. The system of claim 3, wherein said lift system is physically coupled to said first cart.

5. The system of claim 1, wherein said lift system comprises a plurality of extensible support arms, wherein said lift system is shiftable between an extended position wherein at least a portion of said support arms are extended upwardly and a retracted position wherein at least a portion of said support arms are retracted downwardly, wherein said lift system is configured to shift between said extended position and said retracted position within the interior of said first wood treatment vessel.

6. The system of claim 5, wherein said lift system is configured to vertically disengage said bundle of wood from said first cart by shifting from said extended position to said retracted position within the interior of said first wood treatment vessel.

7. The system of claim 6, wherein said lift system is entirely disposed in the lower one-half of the interior volume of said first wood treatment vessel during the vertical disengagement of said bundle from said first cart.

8. The system of claim 5, wherein said lift system is configured in said extended position during at least a portion of the transporting of said bundle of wood into and/or out of said first wood treatment vessel by said first cart.

9. The system of claim 1, wherein said lift system comprises one or more extensible support arms and a support arm drive system operable to retract and/or extend said extensible support arms into and out of the interior of said first wood treatment vessel, wherein said support arm drive system comprises a hydraulic or pneumatic drive component.

10. The system of claim 1, further comprising a second wood treatment vessel, a second cart, and a second lift system for vertically disengaging said bundle of wood from said second cart within the interior of at least one of said first and said second wood treatment vessels.

11. The system of claim 10, wherein said second lift system is configured to vertically disengage said bundle of wood from said second cart within the interior of said second wood treatment vessel.

12. The system of claim 10, further comprising a bundle transport shuttle for moving said first and said second carts back and forth between said first wood treatment vessel and said second wood treatment vessel, wherein said bundle transport shuttle is configured to move in a direction substantially perpendicular to the axes of elongation of said first and/or said second wood treatment vessels, wherein said first and second carts are configured to move relative to said bundle transport shuttle to load and/or unload said bundle of wood from said first and said second wood treatment vessels.

13. The system of claim 10, wherein said first and said second wood treatment vessels are arranged in a side-by-side configuration.

14. The system of claim 10, wherein said first wood treatment vessel is an acetylation reactor for acetylating said bundle of wood and/or said second wood treatment vessel is a microwave heater for heating a bundle of acetylated wood.

15. The system of claim 1, further comprising a bundle support structure configured to support said bundle of wood, wherein said bundle and said bundle support structure are removably supported on said first cart during said transporting of said bundle of wood, wherein said lift system is operable to vertically disengage said bundle of wood and said bundle support structure from said first cart within the interior of said first wood treatment vessel.

16. The system of claim 1, wherein said first wood treatment vessel has an internal volume of at least 500 cubic feet.

17. A process for treating wood, said process comprising:
(a) introducing at least one bundle of wood into a first wood treatment vessel using a first cart, wherein said bundle of wood is supported on said first cart;
(b) while said bundle of wood and said first cart are inside said first wood treatment vessel, removing said bundle of wood from said cart by vertically disengaging said bundle of wood from said cart;
(c) while said bundle of wood is disengaged from said first cart and maintained inside said first wood treatment vessel, removing said first cart from the interior of said first wood treatment vessel; and
(d) treating said bundle of wood in said first wood treatment vessel to thereby provide a treated bundle of wood.

18. The process of claim 17, wherein said treating of step (d) includes chemically modifying and/or heating said bundle of wood.

19. The process of claim 17, further comprising subsequent to said treating of step (d), introducing said first cart or a second cart into the interior of said first wood treatment vessel and transferring said treated bundle of wood onto said first cart or said second cart, wherein said transferring includes lifting said treated bundle of wood and/or lowering said treated bundle of wood; and further comprising removing said treated bundle of wood and said first cart or said second cart from the interior of said first wood treatment vessel.

20. The process of claim 19, wherein at least a portion of said removing of step (b) is carried out with a first lift system and said transferring of said treated bundle is carried out with a second lift system.

21. The process of claim 17, wherein said lift system is physically coupled to said first cart.

22. The process of claim 17, wherein at least a portion of said removing of step (b) is carried out with a lift system having a plurality of extensible support arms for at least partially supporting the weight of said bundle of wood, wherein said removing of step (b) comprises changing the position of one or more of said extensible support arms to thereby vertically disengage said bundle of wood from said first cart within the interior of said first wood treatment vessel.

23. The process of claim 22, wherein said removing of step (b) comprises retracting one or more of said extensible support arms to thereby vertically disengage said bundle of wood from said first cart within the interior of said first wood treatment vessel.

24. The process of claim 22, wherein said removing of step (b) comprises extending one or more of said extensible support arms to thereby vertically disengage said bundle of wood from said first cart within the interior of said first wood treatment vessel.

25. The process of claim 12, further comprising, introducing said treated bundle of wood into a second wood treatment vessel using said first cart or a second cart and, while said first or said second cart is inside said second wood treatment vessel, vertically disengaging said treated bundle of wood from said first or said second cart and removing said first or said second cart from the interior of said second wood treatment vessel; and further treating said treated bundle of wood to thereby provide a further treated bundle of wood.

26. The process of claim 25, wherein said treating of step (d) includes acetylating said bundle of wood to thereby provide an acetylated bundle of wood and/or said further treating comprises heating said acetylated bundle of wood using microwave energy.

27. The process of claim 25, wherein said first and said second wood treatment vessels are arranged in a side-by-side configuration.

28. The process of claim 17, wherein said bundle is supported on a bundle support structure and said removing of step (b) includes vertically disengaging said bundle and said bundle support structure from said first cart, wherein said bundle support structure remains in said first wood treatment vessel during said treating of step (d).

29. The process of claim 17, wherein said bundle of wood has a weight prior to said treating of step (d) of at least 1,000 pounds.
